(19) United States
(12) Patent Application Publication
(10) Pub. No.: US 2020/0153766 A1
(43) Pub. Date: May 14, 2020

(54) REAL-TIME INTERACTIVE COMMUNICATIONS SYSTEM

(71) Applicant: Evite, Inc., Los Angeles, CA (US)

(72) Inventors: Nicolas T. Parr, Los Angeles, CA (US); Victor D. Cho, Burlingame, CA (US); Derek Moore, Cypress, CA (US); Michael Johnson, Simi Valley, CA (US); Tatiane Santos, Los Angeles, CA (US); Lauren Scocozza, Los Angeles, CA (US); Ling Kai Maricela Chan Liang, Monterey Park, CA (US); Roman Balakin, Playa Del Rey, CA (US); Chloe Lew, Sherman Oaks, CA (US)

(21) Appl. No.: 16/680,070

(22) Filed: Nov. 11, 2019

Related U.S. Application Data
(60) Provisional application No. 62/759,977, filed on Nov. 12, 2018.

(51) Int. Cl. H04L 12/58; H04W 4/14; G06F 3/0488; G06F 3/0482; G06F 9/54

(52) U.S. Cl. CPC H04L 51/046; H04W 4/14; G06F 9/542; G06F 3/0482; G06F 3/04883

(57) ABSTRACT

Described herein is a real-time communications system and a method of its operation. Structured datasets can be used to coordinate events. The data within a structured dataset may change dynamically (i.e., in real-time), and as such, can provide up-to-date information to a user. One or more associations can be used for making changes to the structured dataset(s) to facilitate information gathering in an organized fashion. Examples of the disclosure can further include using interactive elements embedded in a communication to allow a user to communicate information in an easier, more streamlined manner. The system further includes additional features to enhance the communications. These additional features include automatically updating members of a group, allowing the host (or the guest) the ability to send a broadcast message, allowing a guest the ability to create an interactive element embedded into a communication, and the ability to communicate with a system-allocated group.

### CROSS-REFERENCE TO RELATED APPLICATION

This application claims benefit of U.S. Provisional Patent Application No. 62/759,977, filed Nov. 12, 2018, the entire disclosure of which is incorporated herein by reference for all purposes.

### FIELD OF THE DISCLOSURE

This disclosure relates to a real-time interactive communication system and a method of its operation.

### BACKGROUND OF THE DISCLOSURE

The Internet and applications have been used for hosting events and sending invitations. The process of hosting an event can begin with a host selecting a time and location for the event, selecting a guest list, and choosing from a number of different invitation designs. In some instances, the invitation can be a digital invitation where the host can add text and then transmit the digital invitation to e-mail addresses of the guests. The invitation can be transmitted to an application located on a device belonging to a guest, for example. The guest can click on a link in the email to open a browser or view the invitation using the application, and then respond to the invitation.

To communicate, the host and guests may have access to an event management page that shows the responses of other guests and any changes to the event from the host. The host and the guests may also use other types of communications such as e-mail, telephone, or Short Message Service (SMS) messages. Such communications can be used for pre-event inquiries, in-event updates, post-event sharing of event-related photos and videos, etc.

In some instances, the conveyance of information and communications between the host and the guests may be asynchronous. The event management page or a group message may be organized such that information is presented in an order related to the timing of when the host or a guest posts the information to the event management page or sends a message. The host or another guest may wish to collect the information, but it may be scattered across the event management page or group message, or some of the information may be outdated. For example, a guest may post an initial response to the event management page, and later, may post a second response. The host may wish to view the guest's response and may have to scroll through the event management page in order to determine that the guest responded twice, and the second response is the guest's updated response.

A system that provides real-time communication and automatically updates the information accessed by a user (e.g., host, a co-host, a guest, a corporate partner) may be desired.

### SUMMARY OF THE DISCLOSURE

Described herein is a real-time communications system and a method of its operation. The real-time communications system can include a plurality of devices that communicate with a server computer through one or more networks. Users of the plurality of devices can be guests, hosts, or both that can access information and can communicate with other users through a respective account. The application can be used to present one or more interfaces to the users.

The server computer can store information related to the accounts. The server computer can also coordinate between a plurality of functions that belong to a plurality of components. The plurality of components can include a pre-event component, an in-event component, and a post-event component. Some functions (e.g., a tracking function) may belong to one component, while other functions (e.g., a charitable cause function) may belong to multiple components.

Examples of the disclosure can further include operating the system such that structured datasets are used to coordinate events. A structured dataset can include a set of data that can be automatically (i.e., by the server computer, without user input) created and organized based on one or more criteria and automatically updated as changes to the data occur. The data within a structured dataset may change dynamically (i.e., in real-time), and as such, can provide up-to-date information to a user.

The system can include multiple structured datasets, such as one that tracks those guests that have responded yes to attending an event, one that tracks the calendar of a guest account, and the like. One or more associations can be used between accounts, options for an event, groups, etc. for making changes to the structured dataset(s) to facilitate information gathering in an organized fashion.

Examples of the disclosure can further include using interactive elements. Interactive elements can be functional controls in a graphical user interface that enable information editing, capture, etc. without requiring textual input. The interactive elements can be embedded in a communication to allow a user to communicate information in an easier, more streamlined manner. Certain interactive elements can be such that one or more actions are automatically performed by the server computer. These actions include, but are not limited to, creating a broadcast message, creating an association, and updating a structured dataset.

The system further includes additional features to enhance the communications. These additional features include automatically updating members of a group, allowing the host (or the guest) the ability to send a broadcast message, allowing a guest the ability to create an interactive element embedded into a communication, and the ability to communicate with a system-allocated group.

### BRIEF DESCRIPTION OF THE DRAWINGS

FIG. 1A illustrates a block diagram of an exemplary real-time communications system, according to examples of the disclosure.

FIG. 1B illustrates a block diagram of an exemplary device, according to examples of the disclosure.

FIG. 1C illustrates a block diagram of an exemplary server computer, according to examples of the disclosure.

FIG. 2 illustrates a block diagram of a plurality of components, according to examples of the disclosure.

FIG. 3 illustrates an exemplary timeline showing updates to a structured dataset, according to examples of the disclosure.

FIG. 4A illustrates an exemplary process flow implemented by a pre-event component, according to examples of the disclosure.

FIG. 4B illustrates an exemplary view of an interface associated with an inquiry function, according to examples of the disclosure.

FIG. 4C illustrates an exemplary view of an interface presenting a host with options for an inquiry, according to examples of the disclosure.

FIG. 4D illustrates an exemplary view of an interface presenting guests with options for an inquiry, according to examples of the disclosure.

FIG. 5A illustrates an exemplary process flow implemented by a pre-event tracking function, according to examples of the disclosure.

FIG. 5B illustrates an exemplary block diagram of a pre-event tracking function and associations, according to examples of the disclosure.

FIG. 5C illustrates a block diagram of an exemplary configuration of structured datasets and associations, according to examples of the disclosure.

FIG. 5D illustrates an exemplary view of an interface associated with a pre-tracking function, according to examples of the disclosure.

FIG. 6A illustrates an exemplary block diagram of a pre-event group function, according to examples of the disclosure.

FIG. 6B illustrates an exemplary block diagram of a pre-event group function after a guest account responds to an event, according to examples of the disclosure.

FIG. 6C illustrates an exemplary view of an interface of a user showing groups that the user belongs to, according to examples of the disclosure.

FIG. 6D illustrates an exemplary view of an interface showing members and details of a group, according to examples of the disclosure.

FIG. 6E illustrates an exemplary view of an interface showing groups and dynamic changes to the groups, according to examples of the disclosure.

FIG. 7A illustrates an exemplary flow associated with a group and a carpool arrangement, according to examples of the disclosure.

FIGS. 7B-7E illustrate exemplary views of interfaces associated with a group and a carpool arrangement, according to examples of the disclosure.

FIG. 8 illustrates an exemplary block diagram of an in-event tracking function, according to examples of the disclosure.

FIG. 9A illustrates a block diagram of an exemplary configuration of communicating a group message according to examples of the disclosure.

FIG. 9B illustrates an exemplary view of an interface of a broadcast message, according to examples of the disclosure.

FIG. 9C illustrates a block diagram of an exemplary configuration of communicating a broadcast message according to examples of the disclosure.

FIG. 10 illustrates an exemplary view of an interface of an event management page associated with an upcoming event, according to examples of the disclosure.

FIGS. 11A-11I illustrate exemplary views of interfaces of communications that include interactive elements, according to examples of the disclosure.

FIG. 12 illustrates an exemplary block diagram of a machine, such as a computer, within which a set of instructions, for causing the machine to perform any one or more of the methodologies discussed herein, may be executed, according to examples of the disclosure.

### DETAILED DESCRIPTION

In the following description of examples, reference is made to the accompanying drawings in which it is shown by way of illustration specific examples that can be practiced. It is to be understood that other examples can be used and structural changes can be made without departing from the scope of the various examples.

Various techniques and process flow steps will be described in detail with reference to examples as illustrated in the accompanying drawings. In the following description, numerous specific details are set forth in order to provide a thorough understanding of one or more aspects and/or features described or referenced herein. It will be apparent, however, to one skilled in the art, that one or more aspects and/or features described or referenced herein may be practiced without some or all of these specific details. In other instances, well-known process steps and/or structures have not been described in detail in order to not obscure some of the aspects and/or features described or referenced herein.

Further, although process steps or method steps can be described in a sequential order, such processes and methods can be configured to work in any suitable order. In other words, any sequence or order of steps that can be described in the disclosure does not, in and of itself, indicate a requirement that the steps be performed in that order. Further, some steps may be performed simultaneously despite being described or implied as occurring non-simultaneously (e.g., because one step is described after the other step). Moreover, the illustration of a process by its description in a drawing does not imply that the illustrated process is exclusive of other variations and modification thereto, does not imply that the illustrated process or any of its steps are necessary to one or more of the examples, and does not imply that the illustrated process is preferred.

Described herein is a real-time communications system and a method of its operation. The real-time communications system can include a plurality of devices that communicate with a server computer through one or more networks. Users of the plurality of devices can be guests, hosts, or both that can access information and can communicate with other users through a respective account. The application can be used to present one or more interfaces to the users.

The server computer can store information related to the accounts. The server computer can also coordinate between functions that belong to a plurality of components. The plurality of components can include a pre-event component, an in-event component, and a post-event component. Some functions (e.g., a tracking function) may belong to one component, while other functions (e.g., a charitable cause function) may belong to multiple components.

Examples of the disclosure can further include operating the system such that structured datasets are used to coordinate events. A structured dataset can include a set of data that can be automatically (i.e., by the server computer, without user input) created and organized based on one or more criteria and automatically updated as changes to the data occur. The data within a structured dataset may change dynamically (i.e., in real-time), and as such, can provide up-to-date information to a user.

The system can include multiple structured datasets, such as one that tracks those guests that have responded yes to attending an event, one that tracks the calendar of a guest account, and the like. One or more associations can be used between accounts, options for an event, groups, etc. for making changes to the structured dataset(s) to facilitate information gathering in an organized fashion.

Examples of the disclosure can further include using interactive elements. Interactive elements can be functional controls in a graphical user interface that enable information editing, capture, etc. without requiring textual input. The interactive elements can be embedded in a communication to allow a user to communicate information in an easier, more streamlined manner. Certain interactive elements can be such that one or more actions are automatically performed by the server computer. These actions include, but are not limited to, creating a broadcast message, creating an association, and updating a structured dataset.

The system further includes additional features to enhance the communications. These additional features include automatically updating members of a group, allowing the host (or the guest) the ability to send a broadcast message, allowing a guest the ability to create an interactive element embedded into a communication, and the ability to communicate with a system-allocated group.

### Overview of an Exemplary Real-Time Communications System

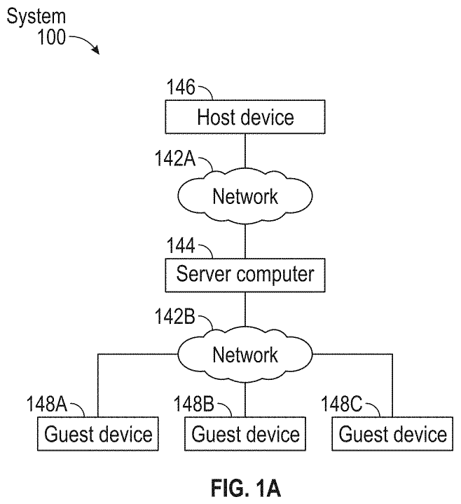

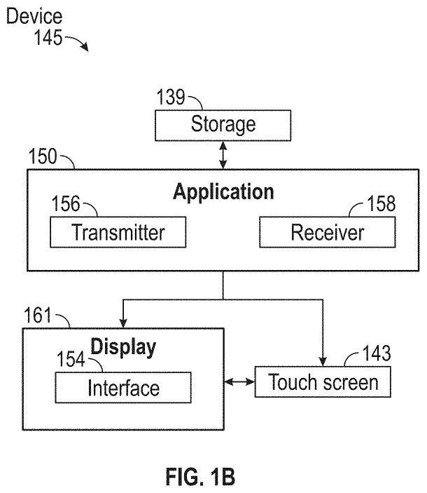

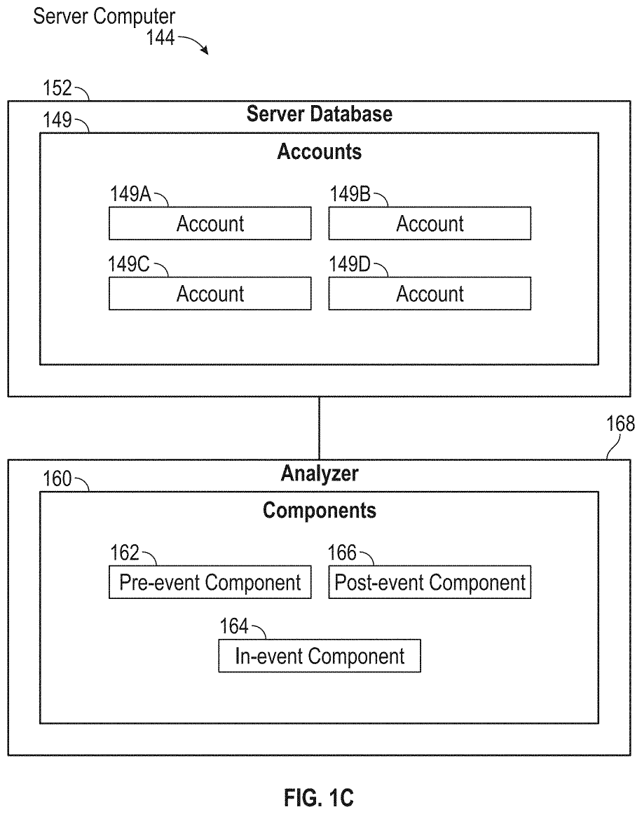

FIG. 1A illustrates a block diagram of an exemplary real-time interactive communication system, according to examples of the disclosure. The system 100 can include a network 142A and a network 142B, a server computer 144, a host device 146, and a plurality of guest devices 148A, 148B, and 148C. In some examples, the system 100 can be used to coordinate an event.

The host device 146 can be coupled to the server computer 144 using the network 142A. The plurality of guest devices 148A, 148B, and 148C can be coupled to the server computer 144 using the network 142B. Although the network 142A and the network 142B are shown as separate components in the figure, it should be understood that both components may in fact be the same network. The network 142A and the network 142B are shown as separate components to illustrate that the host device 146 and the guest devices 148 can communicate with one another via the server computer 144. As discussed below, the host device 146 can initiate communication with the guest devices 148. Additionally, a guest device 148 can initiate communication with the host device 146 and/or another guest device 148.

The server computer 144 can have the ability to communicate and store and analyze data from the host device 146, the guest devices 148, the host account, and the guest accounts.

Additionally, although three guest devices 148A, 148B, and 148C are shown in the figure, examples of the disclosure can include any number of guest devices. Similarly, examples of the disclosure can include any number of host devices 146. A host device 146 and a guest device 148 may have similar functionality and may include similar components where the term “host” and “guest” are used for purposes of describing the relationship of users for a given event. In some examples, a device may be a guest device for one event, but a host device for another event. It should also be understood that a host account can be associated with a host device and a guest account can be associated with a guest device. Also, examples of the disclosure can include multiple devices that can be associated (e.g., used to access) a single account.

As used throughout this disclosure, a reference number without a following alpha character can refer to the plurality of components or steps collectively or can refer to any of the individual components or steps. For example, reference number 148 can refer to all or any one of the guest devices.

FIG. 1B illustrates a block diagram of an exemplary device, according to examples of the disclosure. The device 145 can represent any of the devices shown in FIG. 1A, such as the host device 146, the guest device 148A, the guest device 148B, and the guest device 148C. In some examples, the device 145 can be a portable electronic device, such as a cellular phone, a tablet computer, a laptop computer, or a wearable device. The device 145 can include an application 150, a display 161, and a touch screen 143. The application 150 can include a transmitter 156 and a receiver 158. The application 150 can be in communication with, to receive and transmit information to, the display 161 and the touch screen 143.

The display 161 can include an interface 154, which can provide views to the user (e.g., host or guest). An exemplary interface 154 can include a graphical user interface. The application 150 can be present the interface 154 and can download information for the interface 154 from the server computer 144 and/or an account 149 stored on the server computer 144. The transmitter 156 can transmit views of the interface 154 to the display 161 of the device 145, and the receiver 158 can receive input from a touch screen 143 of the device 145. The device 145 can also include storage 139, which can store and retrieve data from a server database 152 of the server computer 144.

The application 150 can be used to communicate the device with the server computer 144. Information that has been analyzed by and received from the server computer 144 can be transmitted to the transmitter 156. Additionally, information received by the receiver 158 can be transmitted to the server computer 144.

FIG. 1C illustrates a block diagram of an exemplary server computer, according to examples of the disclosure. The server computer 144 can include a server database 152 and an analyzer 168. The server database 152 may store a plurality of accounts 149. Each user may have one or more accounts managed by the server computer 144. For example, a first guest may have an account 149A that can be accessed using the guest device 148A, a second guest may have an account 149B that can be accessed using the guest device 148B, a third guest may have an account 149C that can be accessed using the guest device 149C, and a host may have an account 149D that can be accessed using the host device 146. The accounts 149C can be used for the functions discussed throughout the disclosure, such as communications between users, creation of an event, receipt of an invitation, etc.

The analyzer 168 can include logic to receive information, transmit information, analyze the received information, and coordinate among multiple components 160 and functions.

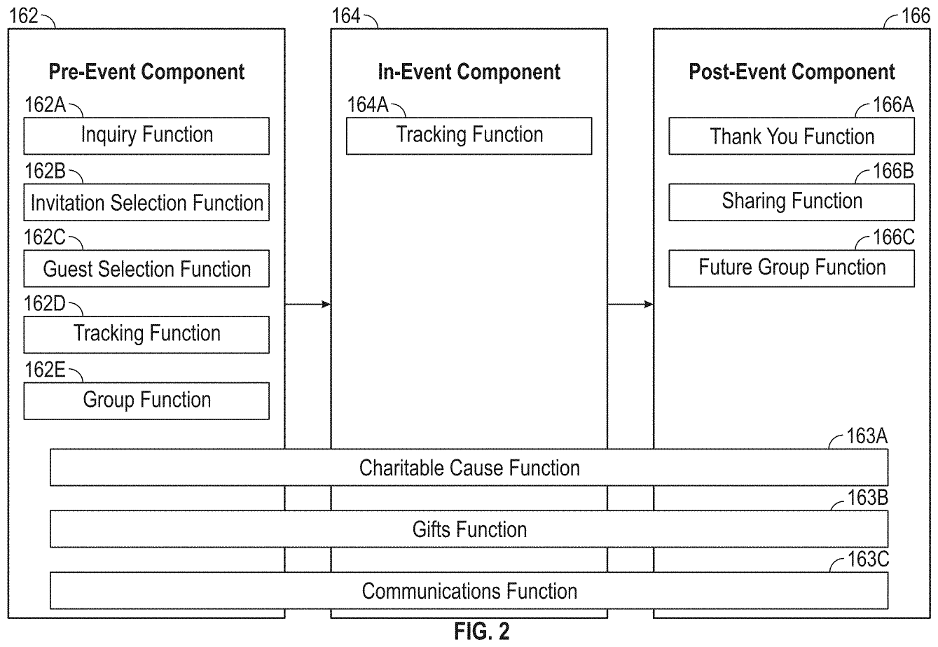

The plurality of components 160 can include different functions related to the multiple stages of an event. The plurality of components 160 can include a pre-event component 162, an in-event component 164, and a post-event component 166. FIG. 2 illustrates a block diagram of the components, according to examples of the disclosure. Each component can include one or more functions related to the timing relative to an event. For example, the pre-event component 162 can include functions related to the planning of the event, and the post-event component 166 can include functions related to follow-up after the event. The pre-event component 162 can implement its functions before the in-event component 164, which can implement its functions before the post-event component 166.

Examples of the disclosure can include an event-based integrated system, where the functions can be implemented on the same platform (e.g., a single application). In this manner, the user may be able to access the system and its multiple capabilities using the same application or the same web browser, for example.

The pre-event component 162 can include, but is not limited to, an inquiry function 162A, an invitation selection function 162B, a guest selection function 162C, a tracking function 162D, and a group function 162E. The in-event component 164 can include, but is not limited to, a tracking function 164A. The post-event component 166 can include, but is not limited to, a thank you function 166A, a sharing function 166B, and a future group function 166C.

The server computer 144 can coordinate between the operation of components and can cause a component to transfer information to another component. For example, the server computer 144 can cause the pre-event component 162 to transfer a list of guests who responded yes to the in-event component 164. As another example, the in-event component 164 can transfer a list guests who attended the event to the post-event component 166. In some examples, these transfers can occur automatically based on the occurrences of the event beginning and ending.

In some examples, one or more functions can be shared among multiple components. For example, a charitable cause function 163A can include raising donations or requesting volunteers for a charitable cause, where coordination of the donations and volunteers can occur at any time before, during, and after the event. Another function can be a gifts function 163B, which can include managing and accessing a gift registry, and contributing to gifts. Yet another function can include a communications function 163C for communicating between users before, during, and after the event.

Additionally, as discussed below, information in the form of a structured dataset can be created, edited, analyzed, and transferred among functions in real-time. Additionally, groups (discussed below) and associated information (e.g., associations) may also be created, edited, analyzed, and transferred in real-time.

### Structured Datasets

As discussed above, information may be transferred between functions and between groups in the form of structured datasets. A structured dataset can include a set of data that can be automatically organized based on one or more criteria and updated as changes to the data occur. The data within a structured dataset may change dynamically (i.e., in real-time), and as such, can provide up-to-date information when accessed by a function. The system can include multiple structured datasets, such as one that tracks those guests that have responded yes to attending an event, one that tracks the calendar of a guest account, and the like. One or more associations can be used between accounts, options for an event, groups, etc. for making changes to the structured datasets to facilitate information gathering in an organized fashion.

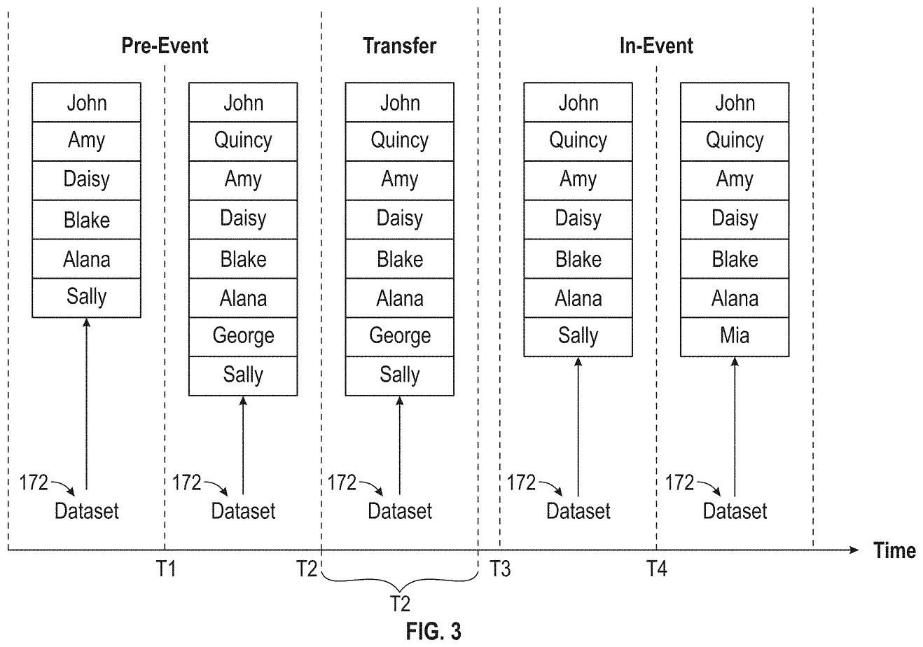

FIG. 3 illustrates an exemplary timeline of a structured dataset, according to examples of the disclosure. The tracking function 162D can be a function that keeps track of one or more responses, such as those guests who responded yes before the event occurs. In some examples, the tracking function 162D can keep track of a response using a structured dataset.

For example, before time T1, the structured dataset 172 can include six guests: John, Amy, Daisy, Blake, Alana, and Sally. At time T1, George and Quincy may have responded yes, and as such, can be added to the structured dataset 172.

In some examples, an entry in a structured dataset can include a reference to the data. For example, the entry for John can include a reference to John's account, and the entry for Amy can include a reference to Amy's account.

The event may begin at time T2, and the tracking function 162D of the pre-event component 162 may transfer the structured dataset 172 to the tracking function 164A of the in-event component 164. Guests may be added and deleted from this structured dataset before the transfer, and as such, the dataset that is transferred can be those guests who responded yes up until the event begins. Although the figure illustrates T2 as being equally as long as the time between T1 and T2, examples of the disclosure can include an instantaneous transfer, and time T2 is exaggerated for purposes of illustration.

After the structured dataset is transferred to the in-event component 164, it may be changed. The tracking function 164A of the in-event component 164 may add and delete guests from the structured dataset when a guest changes his or her response after the event begins. For example, George may change his response to no after the structured dataset 172 has been transferred to the in-event component at time T3, so the structured dataset 172 may be updated with seven guests.

As another example, at time T4, Sally may notify the host that Mia will be taking her spot at the event. The structured dataset 172 may be updated by replacing Sally with Mia, as shown in the figure.

In this manner, the structured dataset 172 can be automatically updated to include up-to-date tracked data that can be transferred to another component or accessed by one or more functions.

### Pre-Event Component and Functions

As shown in FIG. 2, the pre-event component 162 can include multiple functions such as the inquiry function 162A, the tracking function 162D, and the group function 162E, each are discussed in more detail below.

### Inquiry Function

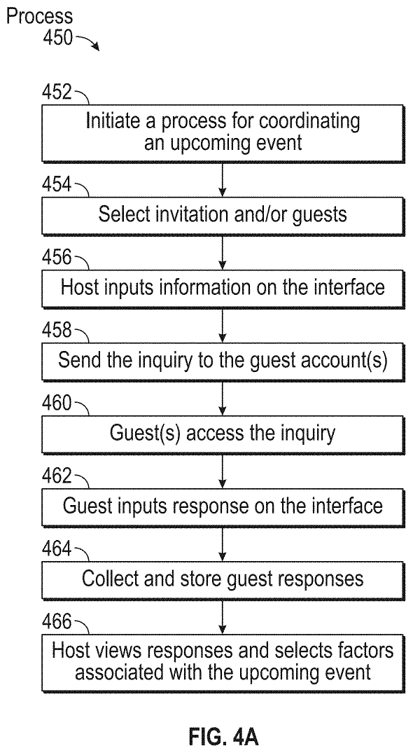

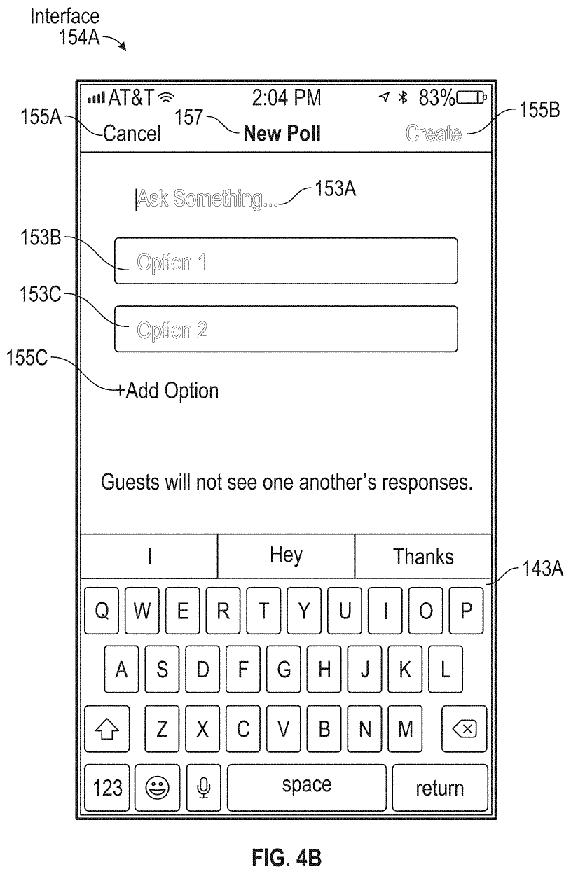

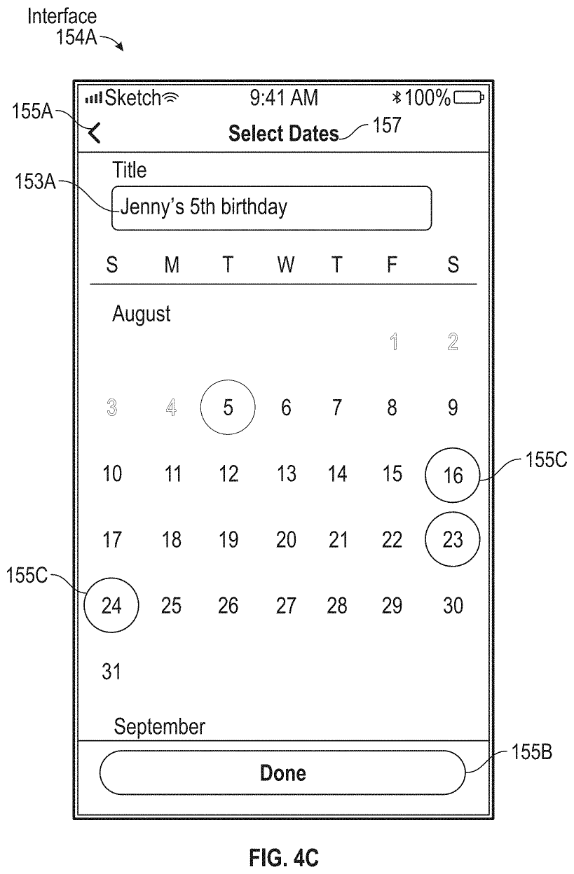

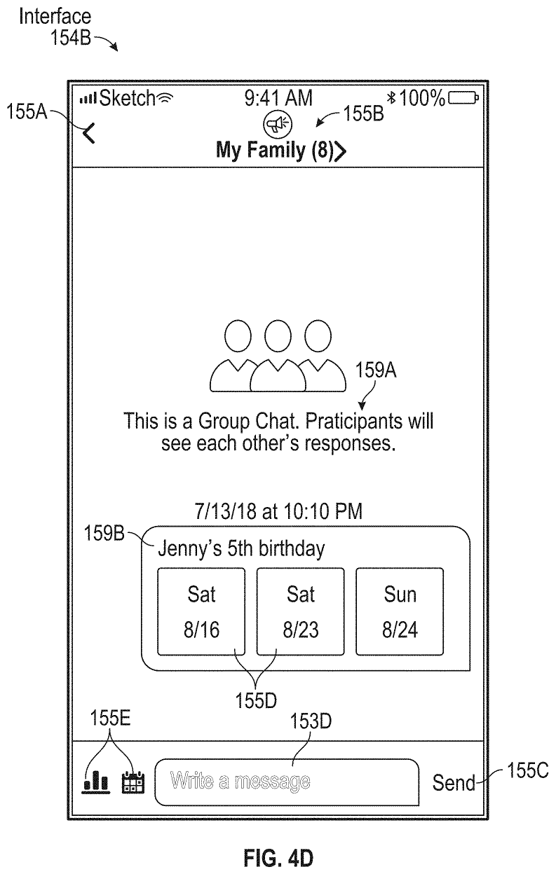

FIG. 4A illustrates an exemplary process flow implemented by a pre-event component, according to examples of the disclosure. The process 450 can, optionally, begin with the host initiating a process for coordinating an upcoming event (step 452). In some examples, the host can initiate the process by accessing his or her account using a host device 146. The initiation step can include using the application 150 of the host device 146 and the server computer 144 to select the invitation and/or the guests (step 454), which can be part of the invitation selection function 162B and the guest selection function 162C of FIG. 2, respectively.

FIG. 4B illustrates an exemplary view of an interface associated with the inquiry function, according to examples of the disclosure. The interface 154A may be a user interface displayed on the display of a device, such as a host device 146. The interface 154A can include a title 157, a plurality of graphical user interface buttons 155, a plurality of input fields 153, and a graphical user interface keyboard 143A.

At step 456, the host can input information on the interface 154A. This input can include inputting information about an inquiry into the fields 153. For example, one field 153A can be used to “Ask something . . . ” to the guests. The host can also enter in text into field 153B and field 153C, labeled “Option 1” and “Option 2,” respectively, for the question asked in field 153A. The host can use the keyboard 143A to enter text into the fields 153. The host may also press one or more buttons, such as button 155A to cancel the inquiry, or button 155B to create the inquiry. The text input on the keyboard 143A and the touch input on the buttons 155 can be sensed by the touch screen 143. Pressing the button 155B can trigger sending the inquiry to one or more guest accounts (step 458).

An inquiry can include factors associated with an upcoming event. Exemplary factors can include, but are not limited to, possible dates, locations, times, and themes for the upcoming event. In some examples, the process 450 may be optional, and the host may send an invitation to an event without sending an inquiry.

In addition to, or instead of, the fields 153, at step 456, the application 150 may provide the host with a plurality of options. FIG. 4C illustrates an exemplary view of an interface presenting the host with options for an inquiry, according to examples of the disclosure. The interface 154A may display a calendar, for example, giving the host a plurality of dates for options. The interface 154A may also include a title 157 that informs the host of the type of options and a field 153A where the host can input the title of the inquiry. The interface 154A can also include a button 155A, which when selected, can return the view back to the previous interface; a button 155B, which can trigger sending the inquiry to the guest account(s) (step 458); and buttons 155C, which can be used by the host to select from the plurality of provided options. A circle, such as shown in the figure, may appear around the options selected by the host. In response to the host's selection, the application 150 may transfer, in real-time, the selected option(s) to the guest account(s) (step 458).

Referring back to FIG. 4A, at step 460, the guest(s) may access the inquiry by accessing their guest account. A guest account can be accessed using a guest device, such as a mobile phone, a tablet computer, a personal computer, or the like.

As shown in FIG. 4D, the interface 154B displayed on the display of a guest device 148 may show the selected options associated with an upcoming event, and the guests may input their response (step 462). For example, as shown in the figure, the guest may be given three date options for Jenny's 5^{th} birthday (message information 159B): Saturday 8/16, Saturday 8/23, and Sunday 8/24.

In some examples, the inquiry can be sent to a selected subset of the guest accounts. For example, as shown in FIG. 4D, the host can send an inquiry to those guest accounts associated with the group “My Family,” as shown by button 155B. Alternatively, the inquiries can be sent to all of the guest accounts, but post-analysis associated with the upcoming event (in step 464) can be based on a selected subset of the guests' responses.

The interface 154B can also include a message title 159A showing that the inquiry is presented to the guests in the form of a group message (discussed in more detail below). The interface 154B can also include message information 159B corresponding to the field 153A input by the host in FIG. 4C and a plurality of buttons 155. The button 155A can be used to return to the previous view of the interface, button 155B can allow the user to determine which guests have access to the group message, buttons 155D can allow a guest to select an option associated with the inquiry, and buttons 155E can allow a guest to view more information (such as how many voted for which date and a calendar). The interface 154B can also allow a guest to input text in a field 153D and send the input text when pressing button 155C (step 462). In this manner, the guest can respond to the host's inquiry.

The interface 154B can illustrate an exemplary communication (e.g., group message) having an embedded interactive element, message 159B. The group message may be a real-time electronic communication between members of the group “My Family.” The server computer 144 may update the group in accordance with any changes to it such that the up-to-date group members receive the communication. For example, if an additional member of “My Family” is added to the group, the additional member may receive the group message. The message 159B may be an embedded interactive element that allows a member of the group to select one of the buttons 155D.

The selection by each of the members can be collected in an organized fashion based on one or more criteria (e.g., dates). For example, all members that selected Saturday, August 16 can be organized together into a group (or sub-group), all members that selected Saturday, August 23 can be organized together in another group (or sub-group), and all members that selected Sunday, August 24 can be organized in yet another group (or sub-group). Structured dataset(s) can be used to keep track of the members in the different groups or sub-groups. If a member changes their selection, the structured datasets, groups, sub-groups, and associations can be updated accordingly.

Although the above example is provided in the context of the pre-event component and functions, examples of the disclosure can include real-time communications at any stage of an event. Examples of the disclosure can include embedded interactive elements and automatically updating groups also at any stage of an event.

An inquiry may be used at any time before or after an invitation is sent. In some examples, the guest can change the response. An exemplary response can include an indication of a RSVP response, a meal selection, the number of people the guest plans to bring to the event, the gift a guest plans to give, etc.

Referring back to FIG. 4A, the guests' responses can be collected and stored in the server database 152 (step 464). The server computer 144 can retrieve the collected responses at any time such as when the last response is received, when a certain guest responds, or when a certain number of guests respond, for example.

A host can view the responses and select certain factors associated with the upcoming event based on the responses (step 466). Alternatively, the server computer 144 can automatically (i.e., without input from the host) select the factors. The automatic selection can be determined based on the option with the most number of positive responses. For example, if the date August 16 has a higher number of positive responses than the date August 23, the server computer 144 can automatically select August 16. Alternatively, the server computer 144 can weigh the responses and can select the option based on weighted summations. In some examples, the server computer 144 can suggest certain options to the host, and the host can decide whether to select the suggested option or manually select another option for a given factor.

As one example, the host can select an option for a given factor, e.g., location, for the event. The location can be selected based on a plurality of locations suggested by the server computer 144 based on, e.g., one or more search criteria input by the host or based on one or more events suggested by the guests during the response step 462. In some examples, the server computer 144 can automatically, without the host's input, associate the selected option to the event at step 464. As other examples, the host can select a time, theme, etc. for the event.

### Pre-Event Tracking Function

Before, during, or after the inquiry function 162A has received responses from the guests, the host can select an invitation using the invitation selection function 162B and/or the guests using the guest selection function 162C. The host may then send the invitation to one or more guests.

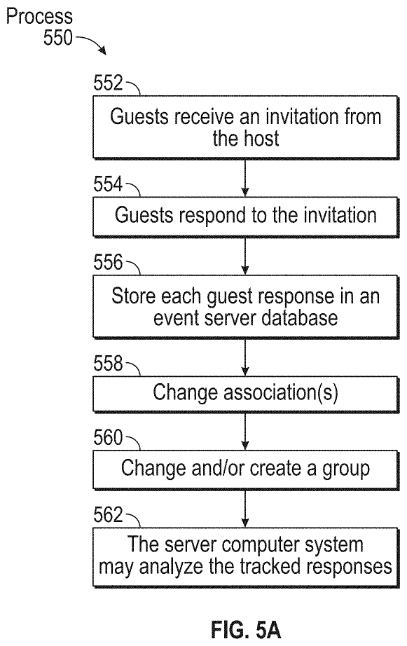

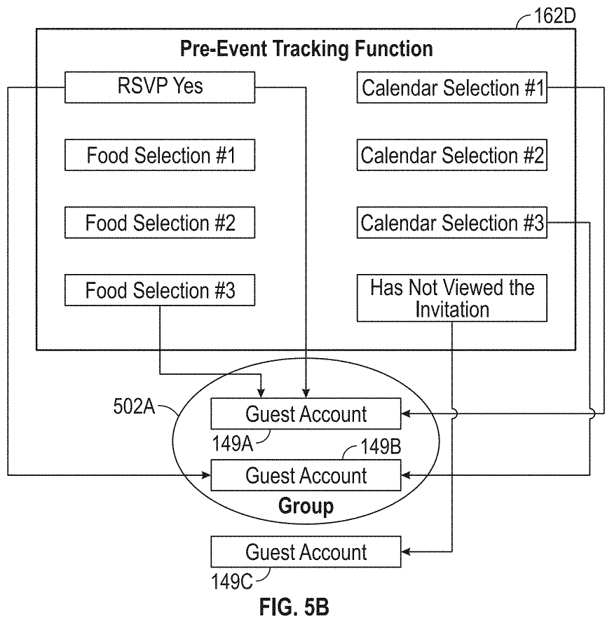

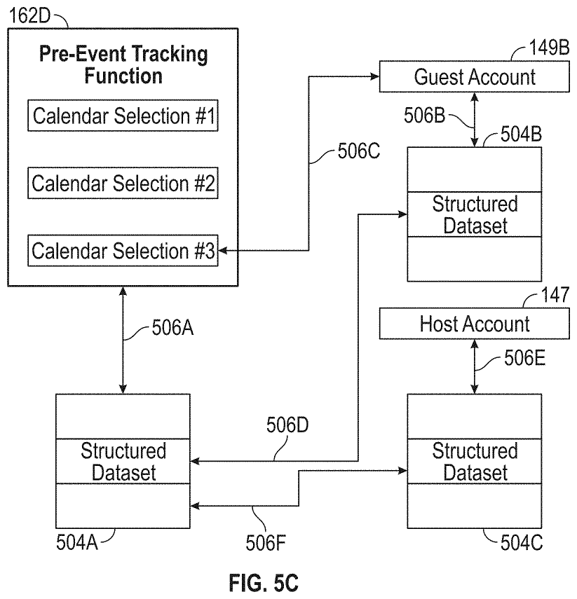

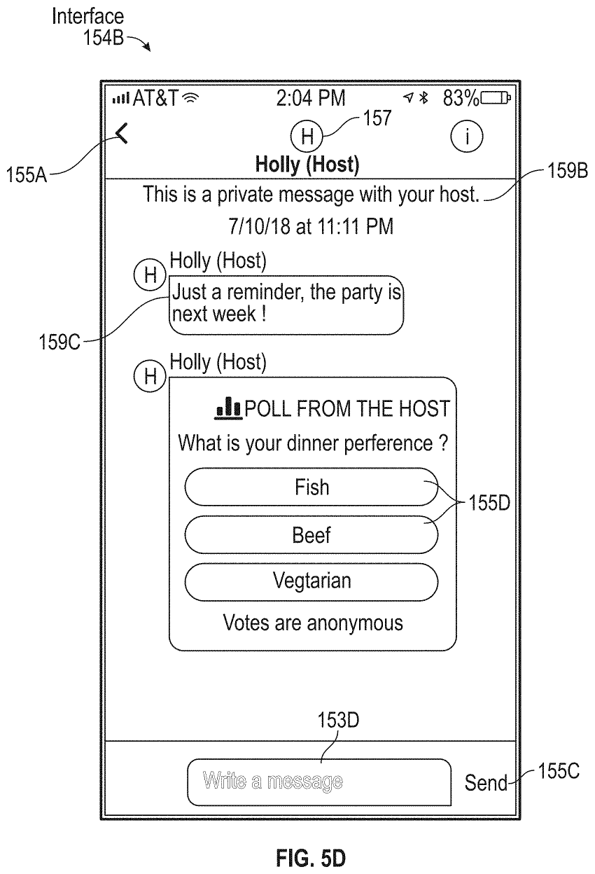

The tracking function 162D can keep track of the guests' responses. FIG. 5A illustrates an exemplary process flow implemented by a pre-event tracking function, according to examples of the disclosure. Process 550 can begin by the guests receiving an invitation from the host (step 552). The guests can respond to the invitation at any time before the event begins (step 554). Each guest response can be stored in the server database 152 (step 556). In response to a given guest response, the server computer 144 can change one or more associations (step 558) and create (or change) a group (step 560). Associations can be created between each option selected by a guest and the corresponding guest account.

The server computer 144 may analyze the tracked responses, which can occur at any time (step 562). The tracking function 162D can track any number of responses, such as those guest accounts that responded yes, food selections, calendar selections, etc. In some examples, each response and each non-response may be considered a unique option.

FIG. 5B illustrates an exemplary block diagram of a pre-event tracking function and associations, according to examples of the disclosure. When a guest accesses an invitation message and/or provides a response, the server computer 144 can create one or more associations. For example, at step 552, all of the guests selected from the guest selection function 162C can be associated with the “Has not viewed the invitation” option. At step 554, the guests associated with the guest account 149A and the guest account 149B can respond yes, which can remove the association of both guest accounts 149A and 149B to the “has not viewed the invitation” option and add associations to the “RSVP yes” option (step 558), as shown in FIG. 5B. Because the two guest selected the same option, the server computer 144 can create a new group 502A (step 560) and associate the two guest accounts 149A and 149B to this group 502A. Groups 502 and the associated group function 162E are discussed in detail below.

In some examples, a guest account may be associated with more than one option. For example, the guest account 149A can be associated with the “RSVP yes” option and the “food selection #3” option. In some examples, more than one guest account can be associated with a given option, such as the guest accounts 149A and 149B being associated with the “RSVP yes” option.

Additionally or alternatively, the server computer 144 can create one or more rules constraining the associations. The rules can be set by the server computer 144 based on the type of event selected by the host, or the host can set the rules. For example, a host may select photography sessions as the type of event, where the server computer 144 may determine that each “calendar selection” option would only have a one-to-one association with a guest account. Once the server computer 144 associates a guest account to a given “calendar selection” option, it may not allow other guest accounts to select the same “calendar selection” option.

As discussed earlier, structured datasets can be accessed by multiple functions. With the photography session example, a structured dataset that maintains the available calendar selections may be created. Before the guest account 149B selects “calendar selection #3,” the structured dataset may include all three calendar selections (i.e., “calendar selection #1,” “calendar selection #2,” and “calendar selection #3”). After the guest account 149B selects “calendar selection #3,” the server computer 144 may create an association (step 558) and may remove this option from the respective structured dataset. If guest account 149C then later accesses the invitation and wants to view the available dates, the tracking function 162D may access this structured dataset to determine which dates are available.

FIG. 5C illustrates a block diagram of an exemplary configuration of structured datasets and associations, according to examples of the disclosure. Structured dataset 504A can be used to track available calendar selections for an upcoming event and can have an association 506A to the pre-event tracking function 162D. Structured dataset 504B can be used to track a calendar for the guest account 149B and can have an association 506B to the guest account 149B. When the guest associated with the guest account 149B looks at his or her calendar, the event can appear on the corresponding date. The guest account 149B may also have an association 506C to the “calendar selection #3” option of the pre-event tracking function 162D due to selection of this option. The selection may also cause an association 506D between the structured dataset 504A and the structured dataset 504B.

Additionally, structured dataset 504C can be used to track a calendar for the host account 147 and can have an association 506E to the host account 147. When the host looks at his or her calendar, available dates, which may be included in the structured dataset 504A, may not be blocked off on the calendar of the host account 147. The structured dataset 504C may also have an association 506F to the structured dataset 504A, where the association 506F may have been created when the host created the event.

If the guest associated with the guest account 149B changes his or her response to no for the event, the server computer 144 may remove the related associations 506C and 506D. If the host cancels the event, the server computer 144 may remove related associations (association 506A, association 506B, association 506C, association 506D, and association 506F) and the related structured dataset 504A. That is, the association(s) may be updated in accordance with one or more changes to responses and/or to the event.

FIG. 5D illustrates an exemplary view of an interface associated with the pre-tracking function, according to examples of the disclosure. The pre-tracking function 162D can track responses at any time before the event and for any type of inquiry. In some examples, the host may send an inquiry after the guests receive an invitation from the host in step 552.

The host, Holly, for example, may send a private message, as shown in the interface 154B of FIG. 5D, to each member of a group. The group may be guests who have responded yes, such as group 502A shown in FIG. 5B. In some examples, the message may be a broadcast message, discussed in more detail below. The inquiry can request a response to one or more options, such as the dinner preference, tracked by the tracking function 162D. Once the guest selects the option, such as “Fish,” the server computer 144 can create an association to the food selection and the guest account and can store the tracked response in the server database 152 (in step 556).

The interface 154B can illustrate another example of an interactive module embedded in a real-time communication. The real-time communication can be a broadcast message, as in this example. The responses from the broadcast message can be collected into the form of one or more structured datasets. The structured dataset(s) can allow the host (or another user) to be able to communicate or take another action related to certain sub-groups, where members of the sub-groups can be grouped based on responses. For example, the host may be able to selectively initiate communicate with those members that responded yes to “Fish.”

In some examples, the inquiry (“Poll From the Host”) may be sent to members associated with a structured dataset, and sub-datasets can be created from the responses. The host may be able to initiate one or more communications, each communication may be unique to members of a sub-dataset.

Examples of the disclosure can include tracking other factors and options such as which guests indicated that their RSVP response would be delayed and which guests requested to bring an additional guest. The “food selection” option discussed above may include not only the food that a given guest wishes to consume, but can also include the food that a given guest wishes to bring to a potluck event, for example.

As another example, the “calendar selection” option discussed above can include not only which date a guest picks for the event, but can also which date a guest prefers over the other dates. In such instances, the guest may have the ability to indicate which option is preferred over the others, and the server computer 144 can weigh the options. Additionally, in some examples, the host may have the ability to respond to the factors and have his/her response tracked along with the guests' responses.

In some examples, one or more responses or changes in responses can cause the server computer 144 to update one or more other functions. For example, a response in step 554 that a certain guest will provide a certain gift can cause the event server 144 to update a registry associated with the gifts function 163B such that the gift is listed as reserved or unavailable. As another example, a response in step 554 can correspond to a guest donating a certain amount to a charitable cause, and the event server 144 can update the amount needed to reach a goal for the charitable cause function 163A.

### Pre-Event Group Functions

The pre-event group function 162E can create one or more groups based on one or more factors. The one or more factors can be a common characteristic such as the guests' selected options, any relationships between guests, common interests of the guests, geographical location of the guests, and the like.

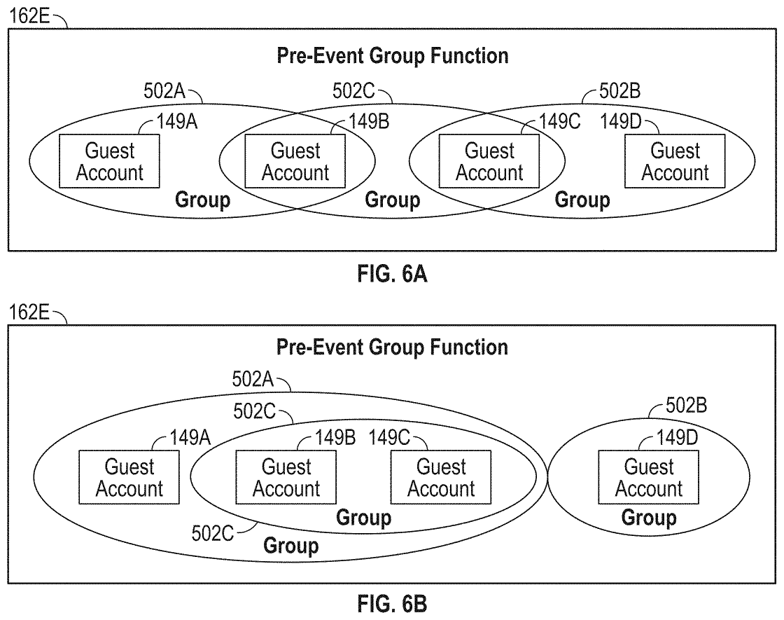

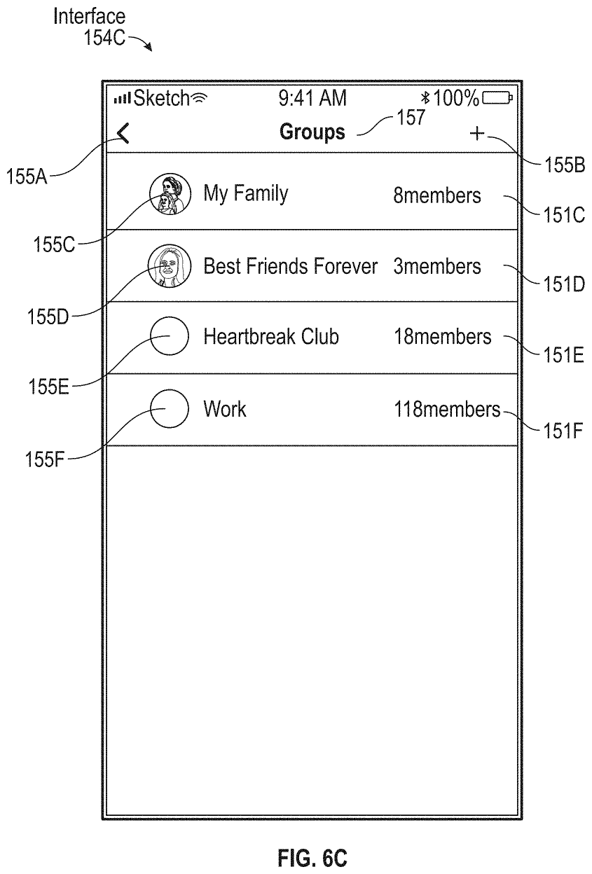

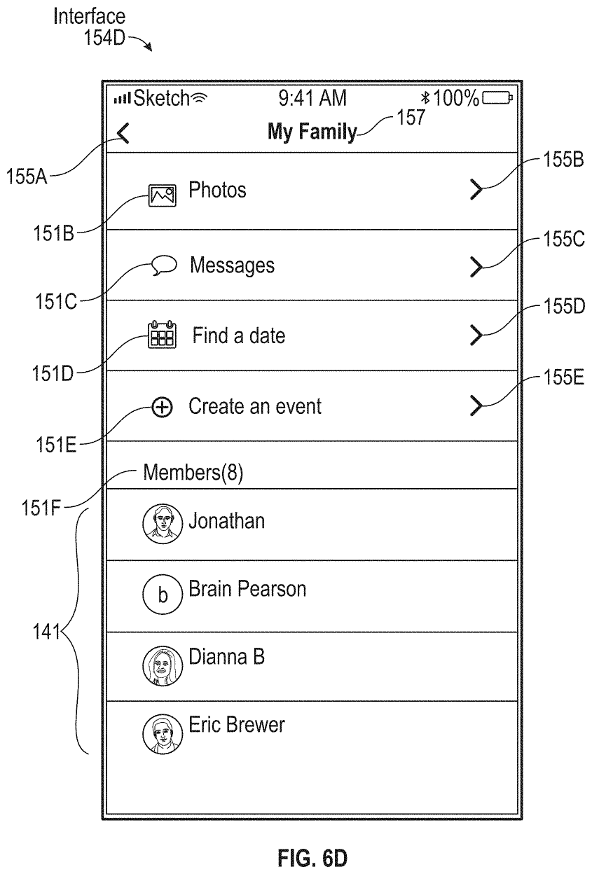

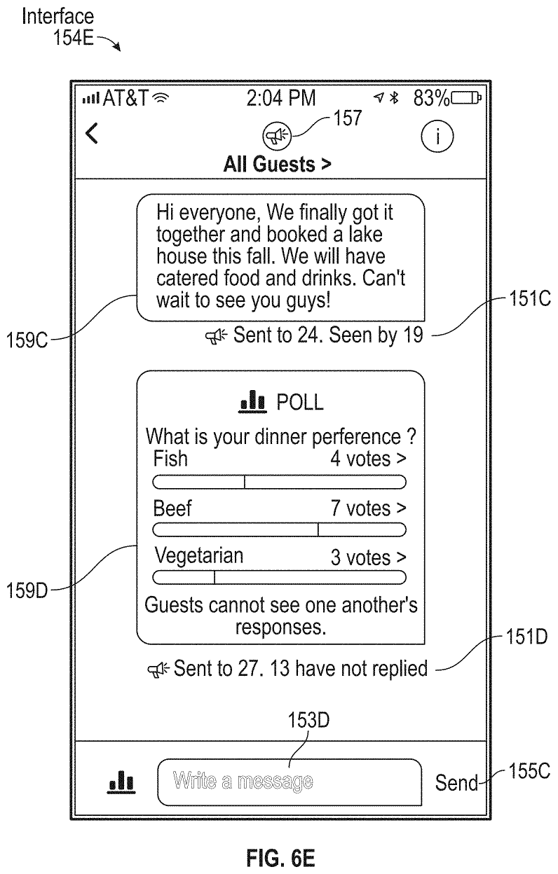

FIG. 6A illustrates an exemplary block diagram of the pre-event group function, according to examples of the disclosure. The pre-event group function 162E can create and maintain one or more groups 502, and in doing so, may group one or more guest accounts to a given group.

For example, as discussed above, the guest account 149A and the guest account 149B can be grouped with the group 502A, which may be a group of guests that responded yes to the event. The guest account 149C and the guest account 149D may be grouped with a different group 502B, which may be a group of guests that have not responded to the event. Examples of the disclosure can include grouping a guest account with multiple groups. For example, the guest account 149B and the guest account 149C may further be grouped with group 502C. The group 502C may be a group of guests that live in the same neighborhood, for example.

As the guests respond or change their response to the factors and options before the event, the pre-event group function 162E may update one or more groups 502 in response to the guest responses. For example, FIG. 6B illustrates the pre-event group function 162E after the guest account 149C responds yes to the event. In response to the guest account 149C responding yes, the guest account 149C can be removed from group 502B and added to the group 502A. The server computer 144 can determine that both the guest account 149B and the guest account 149C belong to two groups, group 502A corresponding to guests that responded yes and group 502B corresponding to guests that live in the same neighborhood. As such, the server computer 144 can notify one or both guest accounts of the change and can allow and/or suggest a sub-event, such as a carpool arrangement, for example.

In some examples, the host or one or more guests can create a group before an event is created and/or the group can be independent from an event. FIG. 6C illustrates an exemplary view of an interface of a user (e.g., host or guest) showing the groups that the user belongs to, according to examples of the disclosure. The interface 154C can include a title 157, a plurality of graphic user interface buttons 155, and a plurality of text 151. The title 157 can indicate that the interface 154C is showing a list of groups that the user belongs to. The button 155A can allow the user to return to the previous view.

As illustrated in the figure, the user may belong to a plurality groups: “My Family,” “Best Friends Forever,” “Heartbreak Club,” and “Work.” The interface 154C may show a profile picture of one of the members for a given group. The interface 154C may also show the number of members in each group in the text 151. Additionally, the interface 154C may provide the user with the option of creating another group using button 155B.

FIG. 6D illustrates an exemplary view of an interface 154D showing the members and details of a group, according to examples of the disclosure. The interface 154D may be presented to the user after selecting the group shown in the interface 154C. For example, the user may select “My Family” in the interface 154C, which may cause the server computer 144, the application 150, and the display 161 to present the interface 154D, shown in FIG. 6D. The interface 154C may include options to access features such as photos associated the group (text 151B and button 155B) and messages between the group (text 151C and button 155C). The interface 154C can list the members in the respective group (list 141) and indicate the number of members in the group (text 151F). The interface 154C may also provide options to the user to find a date for a possible event (text 151D and button 155D) and create an upcoming event (text 151E and button 155E).

Exemplary types of groups can include, but are not limited to, party hosts, party attendees, guests who have not responded, family members, carpool drivers, and out-of-town users. As additional examples, the server computer 144 can suggest directions or parking arrangements to the guests belonging to the carpool drivers group, or the server computer 144 can suggest hotel accommodations to the guests belonging to the out-of-town group. Additionally or alternatively, the host may provide suggested arrangement options for the server computer 144 to present to the guests.

The properties (e.g., associations, members, ways to communicate, etc.) of a group can change dynamically. For example, the members in a group can change as guests RVSP to an event. In some examples, one or more groups can be updated in response to one or more changes. The server computer 144 may update the groups by using associations to the dynamically-changing structured datasets. The server computer 144 can automatically update the groups and associated structured datasets. So, when messages are communicated to a group, the recipients can be up-to-date.

FIG. 6E illustrates an exemplary view of an interface showing groups and dynamic changes to the groups. The interface 154E can be a view of a message sent to “All Guests” (indicated by title 157) for an event. The first message 159C can be a message sent by the host. A text 151C can indicate how many members of the group have received the message 159C (e.g., 24 members) and how many have seen it (e.g., 19 members). This information can be used by the host to gauge different things such as whether the private message was an effective way for communicating to the group, whether to send out another message, etc. Additionally, the host can use this information to send a follow-up message, e.g., to those that did not see the message 159C, while also preventing the host from erroneously sending a follow-up message to those that already received the message.

The interface 154E can also show the host the analysis from an inquiry (“What is your dinner preference”) in the message 159D. The message 159D may be updated in real-time. For example, as shown in the message 159D and text 151D, a total of 14 votes were received, and 13 guests have not responded to the inquiry. When one or more of the remaining 13 guests respond, the votes in the message 159D can be updated accordingly. The message 159D can be an interactive element that is embedded in a communication. The host may, for example, look at which guests voted for “Fish,” which guests voted for “Beef,” and which guests voted for “Vegetarian.” The server computer 144 may collect the responses in the form of structured datasets, and the host may communicate to the different guests using the structured datasets. In some examples, a single structured dataset can be used for each type of vote.

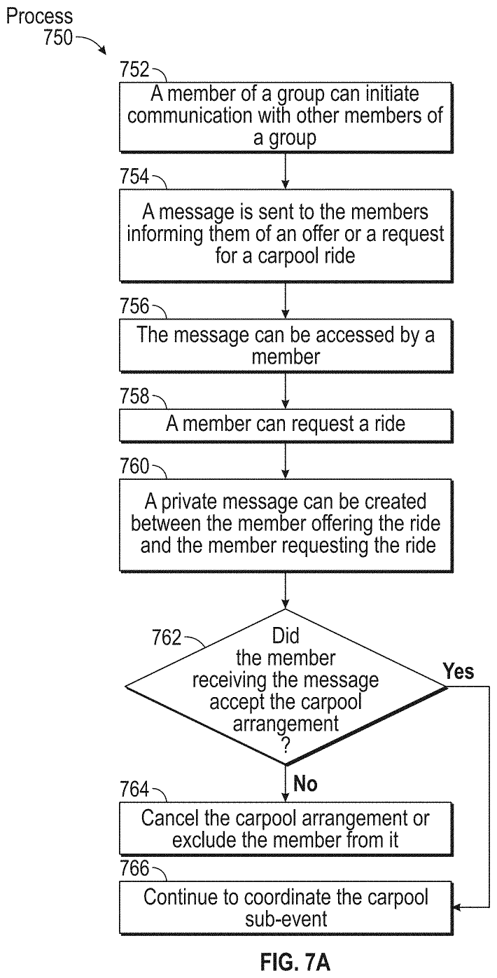

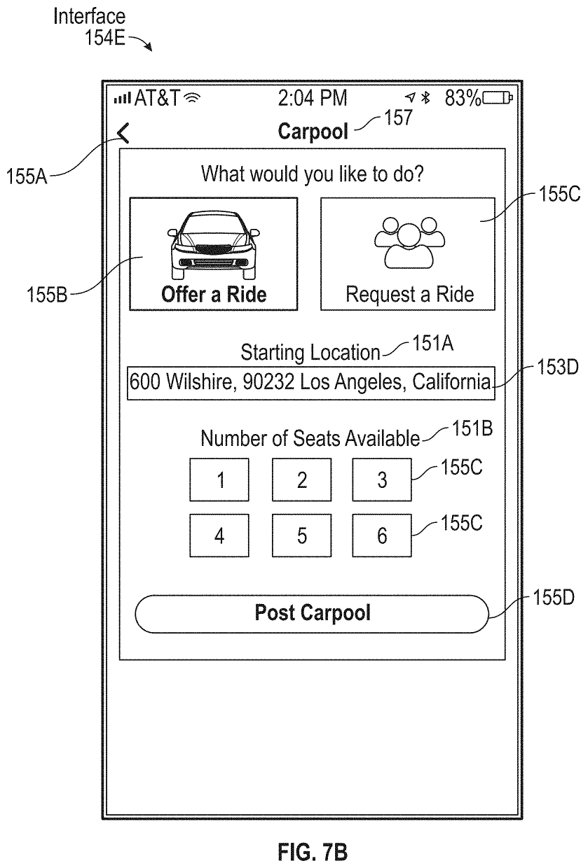

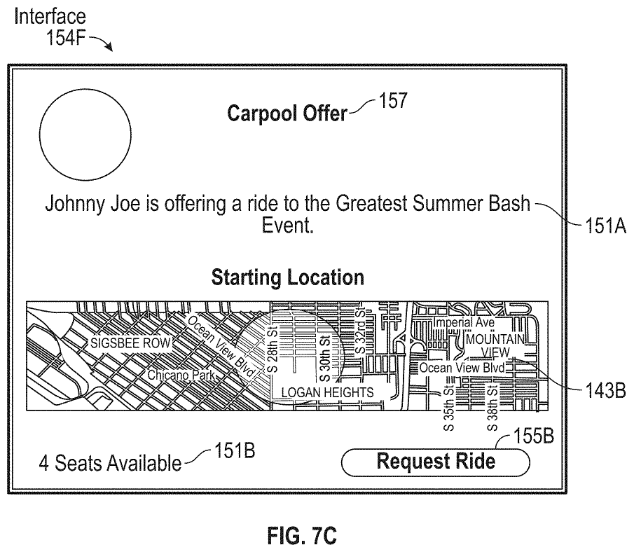

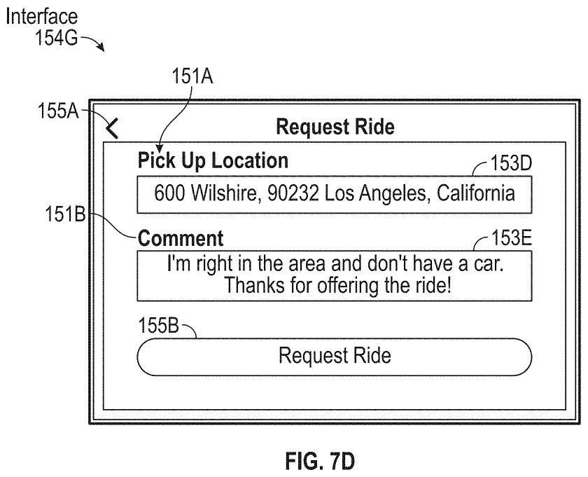

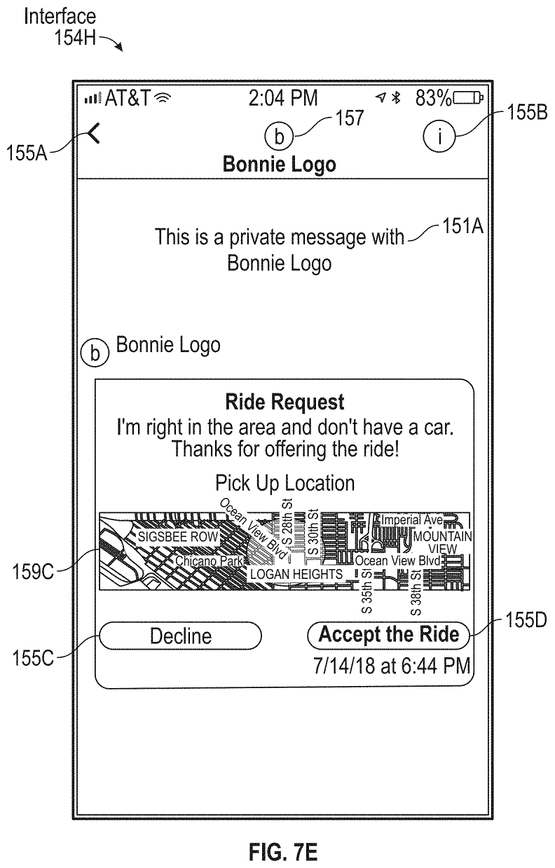

FIG. 7A illustrates an exemplary flow and FIGS. 7B-7E illustrate exemplary views of interfaces associated with a group and a carpool arrangement, according to examples of the disclosure. Process 750 can illustrate an exemplary carpool arrangement, which can be considered a sub-event.

A member of a group can initiate communication with other members of a group (step 752 of process 750). For example, as shown in the interface 154E of FIG. 7B, a member (e.g., guest or host) can offer, or request, a ride to other guests in the carpool group using an initial communication. The communication can be any type of message such as a group text message, or a sub-event invitation message. The interface 154E can include a title 157, a plurality of buttons 155, and a field 153D. The button 155A can allow the member to return to the previous view of the interface, thereby canceling the initiation of an offer or request for a ride. The button 155B can allow the member to offer a ride, while the button 155C can allow the member to request a ride. The interface 153E can include a text 151A, which can request that the member enter the starting location in the field 153D.

If the “Offer a Ride” button 155B is selected, text 151B can request that the member select the “Number of Seats Available” using the buttons 155C. Once the member has filled out the information requested, the member can press the button 155D.

Pressing the button 155D can cause a message to be sent to the accounts of one or more members in the group (step 754). The message can be accessed by a guest, who can view the interface 154F shown in FIG. 7C on a display 161 (step 756). The interface 154F can include a title 157 indicating that the message is a “Carpool Offer.” The text 151A can indicate who is offering the ride (“Johnny Joe”) and for which event (“the Greatest Summer Bash”). The interface 154F can also show a map 143B, which may show the “Starting Location.” In some examples, the interface 154F may indicate the number of “Seats Available” in text 151B. The member may request a ride by pressing the button 155B (step 758).

In some examples, the information presented on an interface may be associated with a structured dataset, which can allow the interface to present to the user up-to-date information. For example, if, while a first user is viewing the interface 154F, a second user reserves one of the four seats available, the interface 154F may update text 151B to indicate three seats as the number. To keep the interface up-to-date, an application 150 may check the server computer 144 for any changes, or the server computer 144 may alternatively send the application 150 an indication every time a change occurs.

After pressing the button 155B on the interface 154F, the member may be presented with the interface 154G, shown in FIG. 7D. The interface 154G includes a plurality of buttons 155, a plurality of text 151, and a plurality of fields 153. The member can return to the previous view by pressing the button 155A. The text 151A can prompt the member to enter in the “Pick Up Location” in the field 153D, and the text 151B can prompt the member to enter in a “Comment” in the field 153D. Once the member enters the information, the member can press the button 155B that is labeled “Request Ride.”

In response to the member requesting a ride, the server computer 144 can create a private message between the member offering the ride in step 754 and the member requesting a ride in step 758 (step 760). An interface showing the message generated by the member requesting the ride can be similar to interface 154H of FIG. 7E. The interface 154H can include a title 157, a plurality of buttons 155, text 151A, and a message 159C. The title 157 can indicate who is accessing the private message; here, the interface 154H shows “Bonnie Logo” as the one viewing the private message she sent. The button 155A can allow the member to return to the previous view, and the button 155B can allow the member to retrieve more information.

Since Bonnie Logo generated the message, the text 151A can indicate so (“This is a private message with Bonnie Logo”). The interface may also include a message 159C that can be automatically generated using the information entered in the interface 154G (of FIG. 7D). The message 159C can include information such as the type of message (“Ride Request”) and comments entered in the field 153E of the interface 154G (“I'm right in the area and don't have a car. Thanks for offering the ride!”). Additionally, the message 159C can illustrate a map of the Pick Up Location corresponding to the address entered in the field 153D (of interface 154G). The message 159C can also include a time stamp showing when it was sent (“Jul. 14, 2018 at 6:44 PM”).

Additionally, the message 159C can include interactive buttons 155C and 155D. The member receiving the message, such as Johnnie Joe, may be able to decline the ride request by pressing the button 155C or accept the ride request by pressing the button 155D (step 762). If the member declines the ride request, the sub-event may be canceled or may exclude that member (step 764). If the member accepts the ride request, the sub-event may continue to be coordinated in step 766. Step 766 can include creating associations to one or more structured datasets, such as one that keeps tracking of which members will be receiving a ride in the carpool arrangement. That is, examples of the disclosure can include sub-events having structured datasets.

Buttons 155C and 155D illustrated in the figure are exemplary interactive elements. Interactive elements can be functional controls in a graphical user interface that enable information editing, capture, etc. without requiring text input. The interactive elements that are embedded in a communication can allow a user to communicate information in an easier, more streamlined manner. Exemplary interactive elements are discussed in more detail below.

Examples of the disclosure can include multiple carpool arrangements associated with a single event (e.g., a birthday party). This is an example of a single event being associated with multiple sub-events. Although the above discussion pertains to a carpool arrangement as a type of sub-event, examples of the disclosure can include other types of sub-events such as babysitting arrangements.

In some examples, information, such as each of the guest responses, can be transferred between the guest accounts in real-time. For example, the logistics of the carpool offer from the guest account 149A can be transferred to the guest account 149B, and the logistics of the request for a ride from the guest account 149B can be transferred to the guest account 149A. In some examples, the transferring of information between the guest accounts can include transferring information to and from the server computer 144.

### In-Event Component and Functions

As shown in FIG. 2, the in-event component 164 can include multiple functions such as a tracking function 164B.

### In-Event Tracking Function

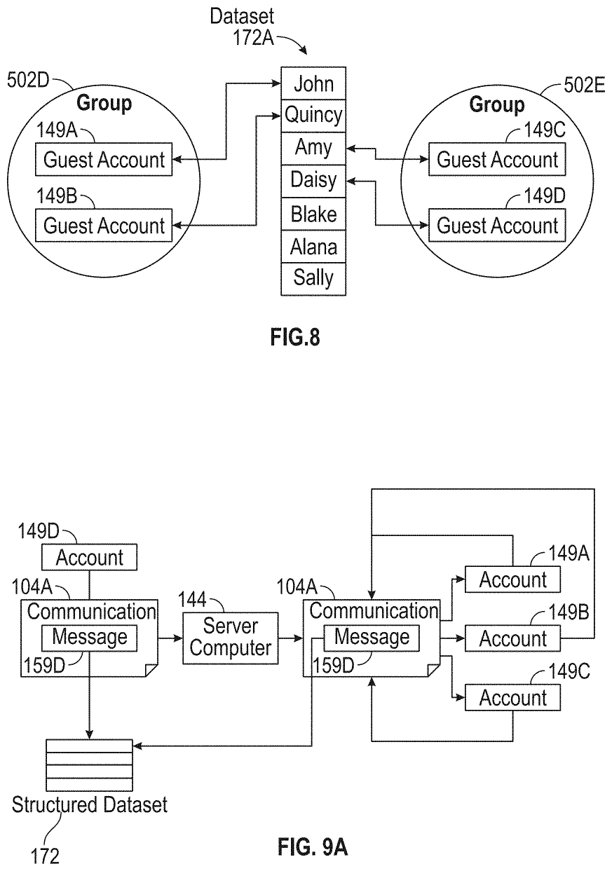

The tracking function 164B can keep track of the guests who attend the event. FIG. 8 illustrates an exemplary block diagram of an in-event tracking function, according to examples of the disclosure. The event system computer 144 can create a structured dataset 172A that can be used to keep track of the guests attending the event in real-time. As shown in the figure, the structured dataset 172A can include seven guests currently at the event. The guests may have used an interactive element that allows the user to communicate a check-in to the event, for example. The structured dataset 172A can be associated with the guest accounts 149 corresponding to those guests attending the event.

In some examples, the structured dataset 172A can be transferred to the post-event component 166 so that certain functions can be performed on the same guests who attended the party. In this manner, the event system computer 144 can send a post-event broadcast message to those guests who attended and can avoid sending messages to guests who did not attend. This structured dataset 172A can also allow the host to send one message (e.g., the broadcast message), instead of manually sending multiple message, one to each guest who attended. The details of a broadcast message are discussed below.

The tracking function 164B can also create one or more groups, such as group 502D and group 502E. For example, the group 502D can include the guests who showed up, but are no longer at the event; and the group 502E can include the guests who are currently at the event. In some examples, the host and/or one or more guests can make such information accessible to other guests.

### Post-Event Component and Functions

As shown in FIG. 2, the post-event component 166 can include multiple functions such as a thank you function 166A, a sharing function 166B, and a future group function 166C. The post-event component 166 may receive one or more structured datasets from the pre-event component 162 and/or the in-event component 164.

For example, the thank you function 166A and the sharing function 166B may receive a structured dataset, such as the structured dataset 172A in FIG. 8, indicating which guests attended the event from the in-event component 164. The host may then generate a broadcast message that is sent to those guests associated with the structured dataset. The broadcast message can include a thank you from the host for attending (thank you function 166A) and a link to photos and videos of the event to be shared among the guests who attended (sharing function 166B).

The future group function 166C may, for example, receive a structured dataset of all the invited guests from the pre-event component 162. The future group function 166C may be similar to the group function 162E and may be used to coordinate a future event.

### Communications Function

As discussed above, the host and guests can communicate with each other using different types of communication, such as group messages and private messages. Group messages can be used to communicate between members of a group. FIG. 4D illustrates an exemplary view of an interface for a group message. The messages sent by each member can be seen by the other members of a group. An exemplary group message can be a message between guests participating in a carpool arrangement. Another exemplary group message can be a message between guests that responded yes to the event.

In some examples, since the members of a group can change dynamically, the recipients of a group message may be updated accordingly. For example, if a user (e.g., host or guest) is a member of the group when a first message is received, he may receive the first message. If later, the user is no longer a member of the group (i.e., not a recipient) and a second message is sent after this change, then the user may not receive the second message. In some examples, the user may be able to access the first message, but not the second message. In other examples, the user may be able to access both the first message and the second message, but may not receive a notification when the second message has been sent to the group members. In this manner, the recipients of the group message may be updated, and the communication may be sent to the updated recipients.

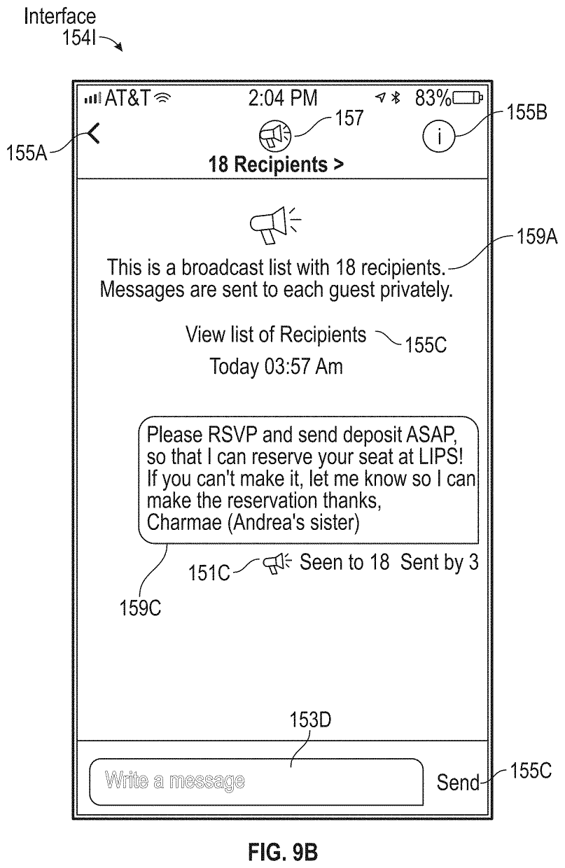

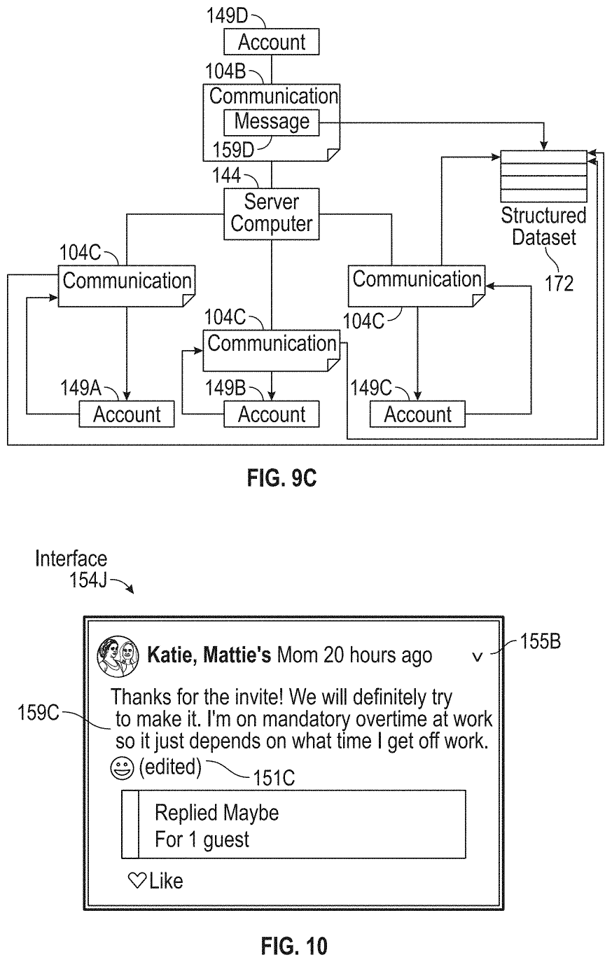

FIG. 9A illustrates a block diagram of an exemplary configuration of communicating a group message according to examples of the disclosure. The account 149D can initiate a communication 104A, which can be a group message. The account 149D can be a host account, for example. The communication 104A can, in some examples, include an interactive element, such as message 159D. The interactive element can be embedded in the communication 104A, as shown in the figure. In some examples, the interactive element can include an association to a structured dataset 172.

The communication 104A can be sent to the server computer 144, which can send the communication 104A to the plurality of accounts 149A, 149B, and 149C. The plurality of accounts 149A, 149B, and 149C can be guest accounts, for example. The plurality of accounts 149 can add, e.g., a message, to the communication 104A, which can be visible to the other users (having the other plurality of accounts 149). When a user adds to the communication 104A, the structured dataset 172 may be updated depending on whether the user changed the data in the structured dataset 172.

Private messages can also be used to communicate between users. The private messages may be used to communicate between only a select few (e.g., two) individuals, where other guests or the host may not be able to see the messages. Exemplary private messages can include a message only between the host and a guest, or a message only between two guests. FIG. 5D illustrates an exemplary view of an interface for a private message.

Yet another type of communication can be a broadcast message. A broadcast message can be a message that a user (e.g., host or guest) creates to be sent to a group, where the server computer 144 creates a plurality of private messages from the user-created message. Each of the plurality of private messages can be copies of portions or all of the user-created message and can be sent to each member of the group. In some examples, any responses to the private message may be received only by the host.

FIG. 9B illustrates an exemplary view of an interface of a broadcast message, according to examples of the disclosure. The interface 154I can include a title 157, a plurality of buttons 155, a message title 159A, a message 159C, text 151C, field 153D, and a button 155C. The title 157 can indicate that the message is a broadcast message and how many recipients have received it. The button 155A can allow the recipient to return to the previous view of the interface, and the button 155B can allow the recipient to find out more information. The message title 159A can indicate that the message is a broadcast message, the number of recipients, and that the messages are sent to each user privately. The button 155C can allow the recipient to view the list of recipients.

The user who sent the broadcast message can input text, which can appear as message 159C. A text 151C can indicate how many of the recipients have seen the message 159C (e.g., 18) and how many have not (e.g., 3). The interface 154I can also allow a user to input text in a field 153D and send the inputted text when pressing button 155C. In this manner, a recipient user can respond to the message in the field 153D via a private message.

FIG. 9C illustrates a block diagram of an exemplary configuration of communicating a broadcast message according to examples of the disclosure. The account 149D can initiate a communication 104B, which can be a broadcast message. The account 149D can be a host account, for example. The communication 104B can, in some examples, include an interactive element, such as message 159D. The interactive element can be embedded in the communication 104B, as shown in the figure. In some examples, the interactive element can include an association to a structured dataset 172.

The communication 104B can be sent to the server computer 144, which can generate and send a plurality of communications 104C to the plurality of accounts 149A, 149B, and 149C. The plurality of accounts 149 can add, e.g., a message, to the respective communication 140C. In some examples, this added message may only be visible to the account 149D. When a user adds to the communication 104C, the structured dataset 172 may be updated depending on whether the user changed the data in the structured dataset 172. The account 149D may then access the structured dataset 172.

Table 1 illustrates exemplary situations where different types of messages can be used, according to examples of the disclosure. Examples of the disclosure can include other situations not explicitly shown in the table.

TABLE 1
Exemplary situations where different types of messages are used

| | | | Broadcast |
|---|---|---|---|
| Group messages | Private messages | | messages |
| Host notifies guests | Guest suggests | Guest asks the | Host thanks guests |
| of an error related to | options for a future | host to setup a | for responding |
| the invitation | event | carpool | |
| | | arrangement | |
| Host provides guests | Provides tips to a | Guest notifies | Host requests |
| with a list of | guest or a host | host of poor | deposit money |
| requested girts | | weather | |
| | | conditions | |
| Host asks guest | Send private contact | Guest asks host | Host sends online |
| whether anyone | information | whether there | link to a registry |
| would be willing to | | will be certain | |
| volunteer for a | | allergy-related | |
| certain position (e.g., | | foods or pets at | |
| goalie of a soccer | | the event | |
| game) | | | |
| Coordinating a | Guest lets host know | Guests ask each | Guests play a game |
| carpool arrangement | that she will be | other questions | during the event |
| | arriving late | | |
| Setting up a future | Guest changes his or | Guest lets the | Host notifies guests |
| event | her RSVP | host know that | of changes to the |
| | | someone else | event or cancels the |
| | | responded on | event |
| | | their behalf | |
| | Guest provides | Guest asks the | Host reminds guests |
| | reason for | host if they can | to RSVP |
| | responding no | pick up their kid | |
| | | up early | |
| | Guest sends wishes | Guest asks the | Host inquiries about |
| | to the host | host what type | a date change |
| | | of attire to wear | |
| | | to the event | |
| | Guest asks the host if | Guest | Host asks guests |
| | they can bring kids | apologizes for | what they are |
| | or another guest | missing the | bringing to the event |
| | | event | |
| | Guest asks about the | Guest asks the | Host thanks guests |
| | logistics of the event | host if they can | for attending |
| | (e.g., what time will | stay the night | |
| | the event be over) | | |
| | Co-host gives the | | |
| | host notes for the | | |
| | event | | |

### Interactive Elements

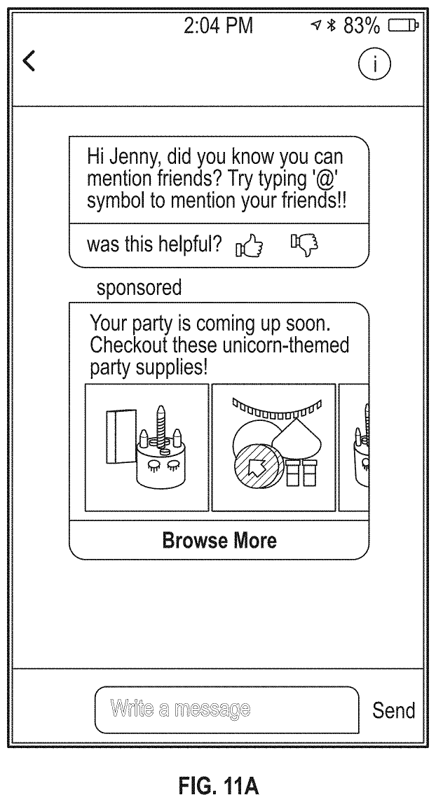

Examples of the disclosure further include interactive elements. One exemplary interactive element can allow a user to change a message after being sent. FIG. 10 illustrates an exemplary view of an interface of an event management page associated with an upcoming event, according to examples of the disclosure. The event management page can be an interface that shows RSVP responses and posted messages to the group of guests invited to an event. The interface 154J can show the message 159C, which can be a posted message from “Katie, Mattie's Mom,” for example. After posting the message 159C, the user, Katie, may wish to edit the contents of message 159C. The message 159C may be an interactive element, where the user may touch the button 155B. Touching the button 155B may cause the interface 154J to present on the interface to the user with one or more options, such as editing the message 159C. The user may edit the message 159C and the text 151C may indicate so with the indicator “(edited).”

Table 2 illustrates exemplary interactive elements, according to examples of the disclosure. Examples of the disclosure can include other interactive elements not explicitly shown in the table. As shown in the table, these interactive elements can be presented on an interface to the user during one or more of the above-discussed components.

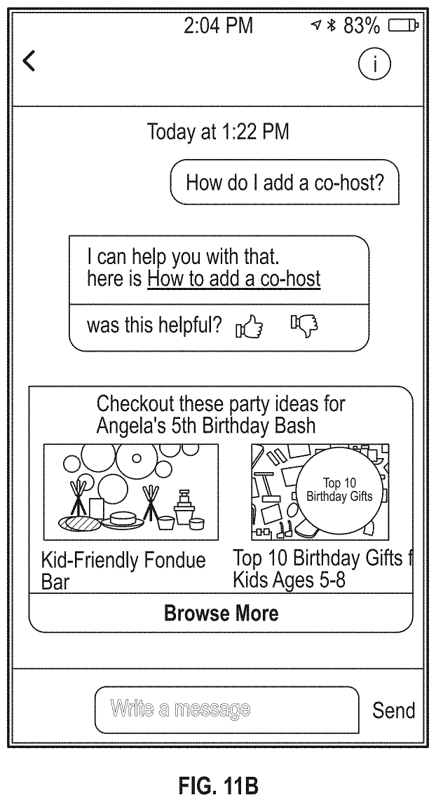

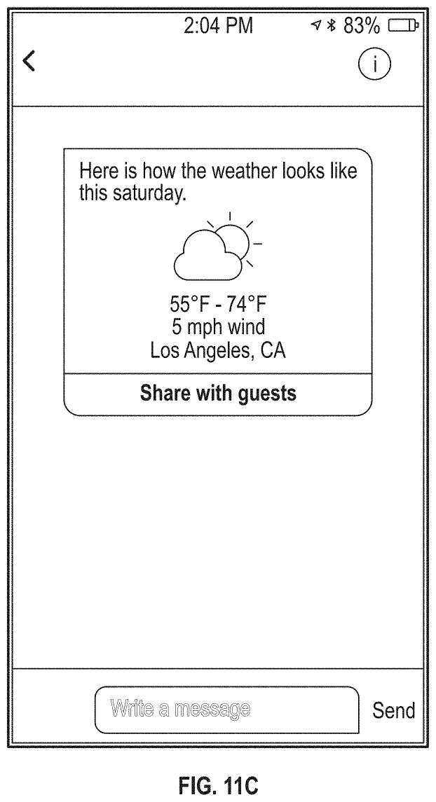

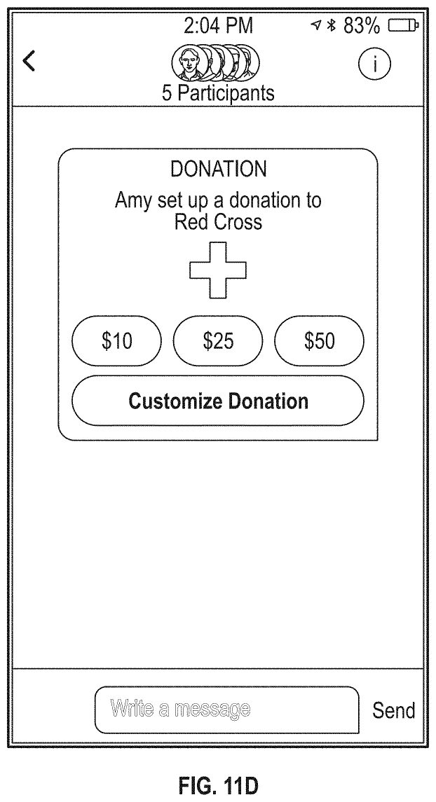

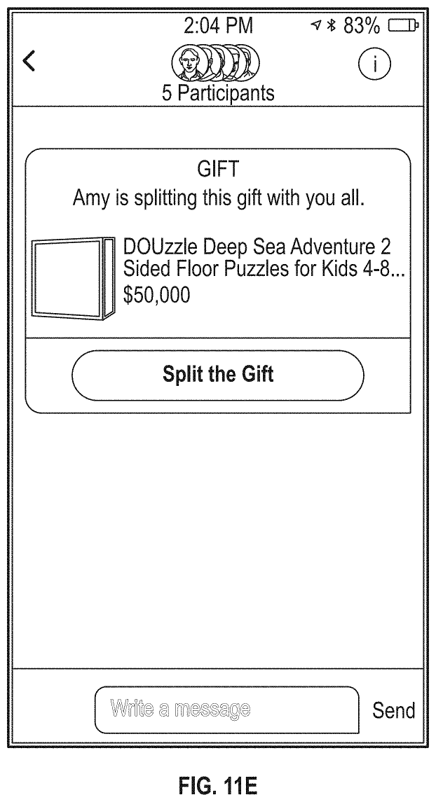

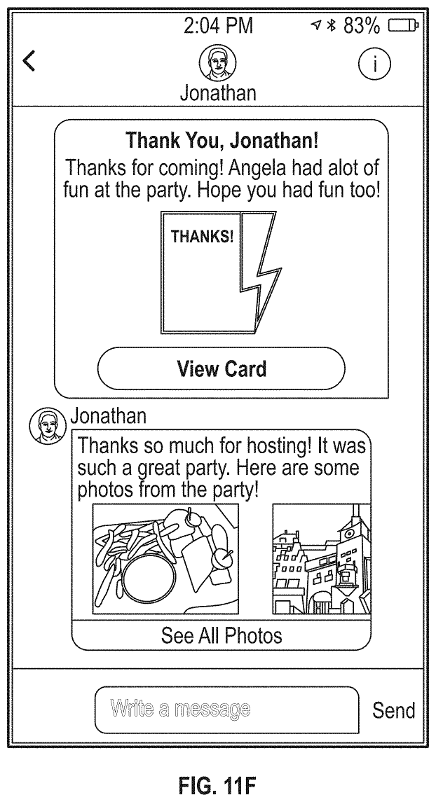

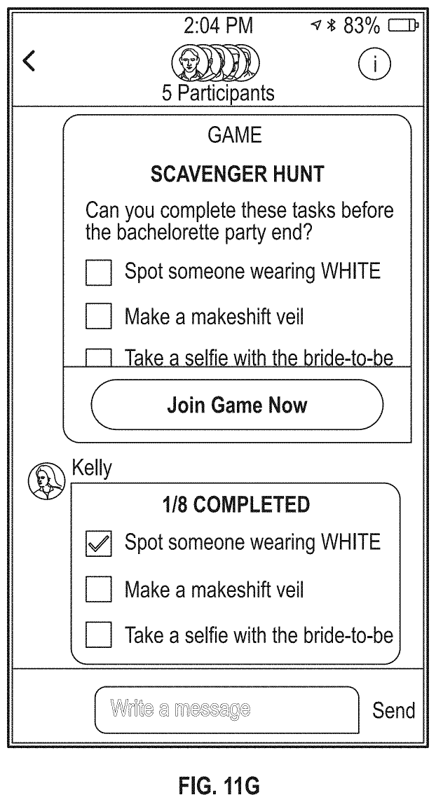

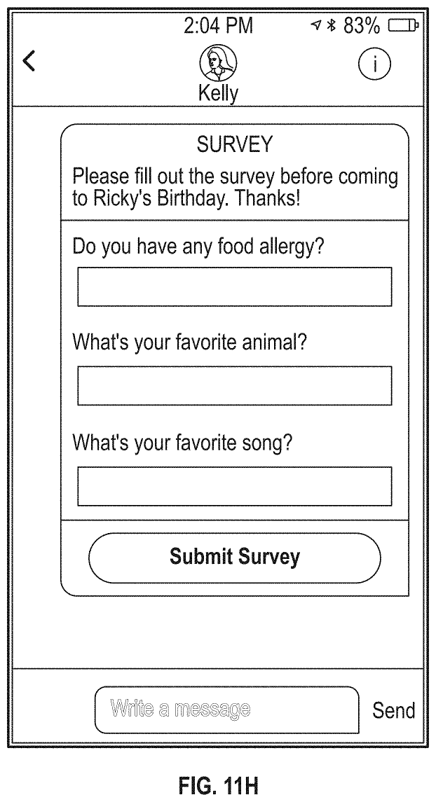

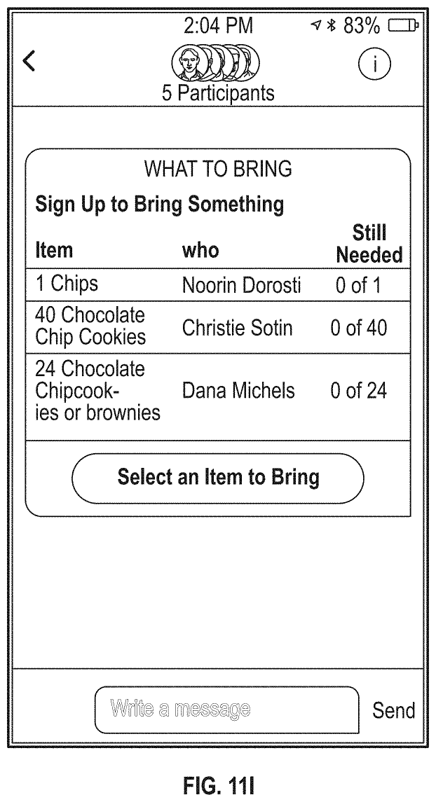

TABLE 2
Exemplary interactive elements

| Pre-Event | In-Event | Post-Event | Multiple |
|---|---|---|---|
| Component | Component | Component | Components |
| Picks an event | Allows guest to | Allows host to thank | Educates user on the |
| | check in when | guests | product |
| | arriving at the | (FIG. 11F) | (FIGs. 11A-11B) |
| | event | | |
| Suggests a | Updates host | Allows guests to | Informs of |
| location or venue | and/or guests on | thank host | sponsorships |
| | the weather | (FIG. 11F) | |
| | (FIG. 11C) | | |
| Makes a | Reminds host | Sharing of photos, | Presents frequently |
| reservation | and/or guests of the | videos, etc. | asked questions |
| | event | | |
| Allows picking | Allows playing a | Sharing of contact | Walks the host |
| and sharing an | party game such as | information | through a checklist |
| invitation design | trivia games | | using a wizard |
| | (FIG. 11G) | | |
| Reminds host | Allows betting on a | | Provides suggestions |
| and/or guests of | sports game | | for, e.g., reminders |
| the event | | | or things to bring |
| Provides an up- | Allows host and/or | | Provides party |
| to-date checklist | guests to share | | integration ideas |
| of what to bring | their location | | |
| (FIG. 11I) | | | |
| | Updates guests of | | Collects payments or |
| | the party schedule | | donations from |
| | and activities | | guests (FIG. 11D) |
| | | | Splitting gifts or |
| | | | money |
| | | | (FIG. 11E) |
| | | | Surveys the host |
| | | | and/or guests |
| | | | (FIG. 11H) |
| | | | Allows photo editing |
| | | | and adding stickers, |
| | | | gifs, etc. |
| | | | Suggests contextual |
| | | | messages |

FIGS. 11A-11I illustrate exemplary views of interfaces of communications that include interactive elements, according to examples of the disclosure. FIG. 11A shows an interactive element that can educate a user on a product. The server computer 144 can generate the message shown in the figure. The server computer 144 can allow the user to respond to the message. The message can also include an interactive element that can suggest products, ideas, services, etc. In some examples, the interactive element can be associated with a corporate partner, as indicated by the text “sponsored.” The interactive element, when it receives an input from the user pressing the “Browse More” button, can direct the user to the corresponding linked webpage.

The server computer 144 can allow the user to ask a question, as shown in FIG. 11B. In response to the question, the server computer 144 can direct the user to the proper frequently asked question page. The server computer 144 may also direct the user to one or more other webpages, such as one that suggests party ideas. The interactive element, when it receives an input from the user pressing the “Browse More” button, can direct the user to the corresponding linked webpage.

In some examples, the server computer 144 can inform the user of the weather conditions on the day of the event, as shown in FIG. 11C. The interactive element shown in the figure can allow, e.g., the host, to share the information with the guests of the event. The shared information may be sent to the corresponding guest accounts, who may, in some examples, receive the information in the form of an interactive element.

An interactive element may also be used to collect payments or donations from guests. FIG. 11D illustrates an exemplary view of an interface including an interactive element used to setup a donation to the Red Cross. The interactive element can allow the recipient the ability to select how much to donate.

Guests may also split gifts given to a person of honor, as shown in FIG. 11E. The interactive element can allow a certain number (e.g., five) of participants to share the costs of one or more gifts.

In some examples, a user may create an interactive element in his or her response to an interactive element. A first user, such as the host, may send out thank you messages to one or more second users, such as a guest. The thank you message may be a broadcast message and may include an embedded interactive element, such as one that allows the guests to view the thank you card by touching the “View Card” button. In the example, shown in FIG. 11F, the guest may be named “Jonathan.” The guest may respond to the host's message by thanking the host for hosting the party. The guest may also include, in the response, another embedded interactive element. The second embedded interactive element may allow the guest to photos from the party in a simple, easy manner. Additionally, the second embedded interactive element may allow the host to view the photos by clicking a single button titled “See All Photos.” Additionally, the interactive element may include a preview (e.g., photos) of the information associated with the button.

Examples of the disclosure can further include an interactive element that can be used to play games during the event. FIG. 11G illustrates an exemplary view of an interface of a party game. One exemplary game can include a scavenger hunt, as shown in the interactive element. The guests may be presented with a list of tasks for the scavenger hunt, and each guest may be able to check the tasks that have been completed. The interface may show the guest how many and which of the tasks are remaining. In some examples, the host may be presented with a compilation of up-to-date game information, such as how many guests have completed the first task, which guest has the most tasks completed at the time, etc. Other exemplary games that use an interactive element can include betting on which sports team will win a sports game and trivia questions that can include a timer.

As another example, an interactive element can be used send surveys and receive corresponding information. For example, as shown in FIG. 11H, Kelly may be a guest asked to fill out a survey before coming to “Ricky's Birthday.” Exemplary survey questions can include, but are not limited to, whether the guest has a food allergy, how much the guest is willing to spend on a gift or the event, what is the guest's favorite animal/song/food, whether the guest enjoyed the party, whether the guest has any suggestions on how to improve the party.

FIG. 11I shows another example of an interactive element. The interactive element of FIG. 11I can be used to coordinate a potluck, for example. The interactive element can allow users to sign up for which items to bring to the potluck. As each user signs up for an item, the sever computer 144 can update the “Still Needed” entries such that each user is updated in real-time. In this manner, the situation where a user signs up for the last available item at the same time as another user can be avoided.

As discussed above, a single application can be capable of allowing a user to access capabilities associated with multiple components related to an event. The single application can also transmit notifications to the interface of the display of a device using a transmitter, for example. The notifications can be transmitted in response to one or more changes to a component, such as the host changing the location of an event, or a communication, such as a member posting a message in a group message.

### Exemplary Machine

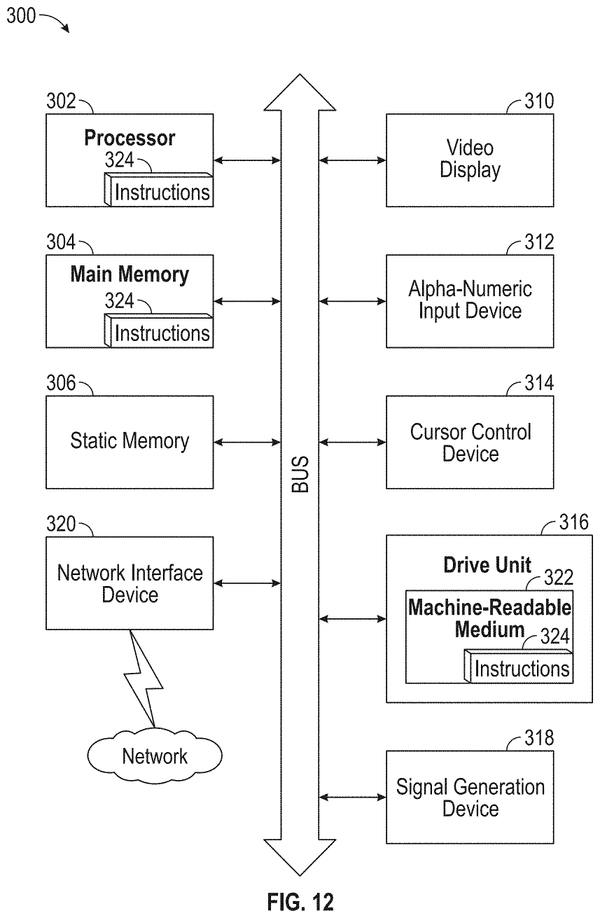

FIG. 12 illustrates an exemplary block diagram of a machine, such as a computer, within which a set of instructions, for causing the machine to perform any one or more of the methodologies discussed herein, may be executed, according to examples of the disclosure. In some examples, the machine can operate as a standalone device or may be connected (e.g., networked) to other machines. In a networked configuration, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing a set of instructions (sequential or otherwise) that specify actions to be taken by that machine. A mobile device such as a PDA or a cellular phone may also include an antenna, a chip for sending and receiving radio frequency transmissions and communicating over cellular phone WAP and SMS networks, and a built-in keyboard. Further, while only a single machine is illustrated, the term “machine” shall also be taken to include any collection of machines that individually or jointly execute a set (or multiple sets) of instructions to perform any one of the methodologies discussed herein.

The exemplary computer 300 includes a processor 330 (e.g., a central processing unit (CPU), a graphics processing unit (GPU), or both), a main memory 332 (e.g., read-only memory (ROM), flash memory, dynamic random access memory (DRAM) such as synchronous DRAM (SDRAM) or Rambus DRAM (RDRAM), etc.), and a static memory 334 (e.g., flash memory, static random access memory (SRAM), etc.), which can communicate with each other via a bus 336.

The client computer 300 may further include a video display 338 (e.g., a liquid crystal display (LCD) or a cathode ray tube (CRT)). The client computer 300 also includes an alpha-numeric input device 340 (e.g., a keyboard), a cursor control device 342 (e.g., a mouse), a disk drive unit 344, a signal generation device 346 (e.g., a speaker), and a network interface device 348.

The disk drive unit 344 includes a machine-readable medium 350 on which is stored one or more sets of instructions 352 (e.g., software) embodying any one or more of the methodologies or functions described herein. The software may also reside, completely or at least partially, within the main memory 332 and/or within the processor 330 during execution thereof by the client computer 300, the main memory 332 and the processor 330 also constituting machine-readable media. The software may further be transmitted or received over a network 354 via the network interface device 348.

While the machine-readable medium 350 is shown in an exemplary embodiment to be a single medium, the term “machine-readable medium” should be taken to include a single medium or multiple media (e.g., a centralized or distributed database and/or associated caches and servers) that store the one or more sets of instructions. The term “machine-readable medium” shall also be taken to include any medium that is capable of storing, encoding, or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Representative applications of methods and apparatus according to the present disclosure are described in this section. These examples are being provided solely to add context and aid in the understanding of the described examples. It will thus be apparent to one skilled in the art that the described examples may be practiced without some or all of the specific details. Other applications are possible, such that the following examples should not be taken as limiting.

A method is disclosed. In some examples, the method can comprise: allowing at least two users to communicate information to each other using a real-time electronic messaging system, the at least two users included in a group and including a first user, wherein the communication of the information includes: allowing the first user to input a first information in an electronic message using a first graphical user interface, wherein the electronic messaging system is capable of receiving the input of the first information using an interactive element embedded in the electronic message; receiving the first information at a first time; and in accordance with the first information being input using the interactive element: automatically creating or updating one or more first structured datasets in accordance with the information at the first time, and allowing the group access to the one or more first structured datasets at the first time. Additionally or alternatively, in some examples, the electronic message is one of: a private message, a group message, and a broadcast message. Additionally or alternatively, in some examples, the electronic message is a broadcast message, the method further comprising: in response to the input of the first information: creating a plurality of private messages, each of the plurality of private messages includes the input of the first information, and sending the plurality of private messages to the group. Additionally or alternatively, in some examples, the method further comprises: in response to the input of the first information, receiving one or more responses to the plurality of private messages, wherein the electronic messaging system allows access to each of the plurality of private messages by the first user and one user of the group. Additionally or alternatively, in some examples, the method further comprises: receiving one or more responses to at least one of the plurality of private messages at a second time; and automatically creating or updating one or more second structured datasets at the second time to include the one or more received responses. Additionally or alternatively, in some examples, the method further comprises: allowing the first user to access the updated one or more second structured datasets. Additionally or alternatively, in some examples, the method further comprises: allowing the first user to send another electronic message to users associated with the one or more second structured datasets. Additionally or alternatively, in some examples, the electronic message is a group message, and wherein the input of the first information causes a broadcast message to be created. Additionally or alternatively, in some examples, the input of the first information by the first user causes a change to the group, the method further comprising: automatically updating the group to reflect the change to the group. Additionally or alternatively, in some examples, the method further comprises: allowing one or more of the at least two users to input second information in the electronic message; receiving the input second information; and transmitting the input second information to the updated group. Additionally or alternatively, in some examples, the input of the first information includes: creating the interactive element embedded in the electronic message. Additionally or alternatively, in some examples, the electronic message is related to an event. Additionally or alternatively, in some examples, the input first information is received through the interactive element, and wherein the allowance of the group access to the one or more structured datasets at the first time includes: automatically updating graphical user interfaces of the electronic message to the group at the first time. Additionally or alternatively, in some examples, the at least two users includes one or more of a: host, co-host, guest, and company. Additionally or alternatively, in some examples, the allowance of the first user to input the first information in the electronic message using the first graphical user interface includes: allowing the first user to enter text on the first graphical user interface.

An electronic application is disclosed. In some examples, the electronic application comprises: a transmitter that transmits one or more views of one or more interfaces of a display of a portable electronic device, the one or more views including information analyzed by and received from a server computer, wherein a first interface of the one or more interfaces includes a first interactive element embedded in an electronic message; and a receiver that receives input information from a touch screen of the portable electronic device and transmits the received input information to the server computer, the input information associated with the first interactive element, and when received, causing the sever computer to automatically create or update one or more first structured datasets, wherein the transmitter transmits a second interface of the one or more interfaces in response to updates to the one or more first structured datasets. Additionally or alternatively, in some examples, the second interface of the one or more interfaces includes the first interactive element and a second interactive element embedded in the electronic message. Additionally or alternatively, in some examples, the first interactive element includes at least one button, and the second interface is a view of a webpage associated with the at least one button of the first interactive element. Additionally or alternatively, in some examples, the first interface allows a user to input text into a field input, and the second interface displays the input text. Additionally or alternatively, in some examples, the electronic message is one of: a private message, a group message, and a broadcast message, and wherein the input information is related to an event.

Although the disclosed examples have been fully described with reference to the accompanying drawings, it is to be noted that various changes and modifications will become apparent to those skilled in the art. Such changes and modifications are to be understood as being included within the scope of the disclosed examples as defined by the appended claims.

1. A method comprising:
allowing at least two users to communicate information to each other using a real-time electronic messaging system, the at least two users included in a group and including a first user, wherein the communication of the information includes:
allowing the first user to input a first information in an electronic message using a first graphical user interface,
wherein the electronic messaging system is capable of receiving the input of the first information using an interactive element embedded in the electronic message;
receiving the first information at a first time; and
in accordance with the first information being input using the interactive element:
automatically creating or updating one or more first structured datasets in accordance with the information at the first time, and
allowing the group access to the one or more first structured datasets at the first time.

2. The method of claim 1, wherein the electronic message is one of: a private message, a group message, and a broadcast message.

3. The method of claim 1, wherein the electronic message is a broadcast message, the method further comprising:
in response to the input of the first information:
creating a plurality of private messages, each of the plurality of private messages includes the input of the first information, and
sending the plurality of private messages to the group.

4. The method of claim 3, the method further comprising:
in response to the input of the first information, receiving one or more responses to the plurality of private messages, wherein the electronic messaging system allows access to each of the plurality of private messages by the first user and one user of the group.

5. The method of claim 3, the method further comprising:
receiving one or more responses to at least one of the plurality of private messages at a second time; and
automatically creating or updating one or more second structured datasets at the second time to include the one or more received responses.

6. The method of claim 5, the method further comprising:
allowing the first user to access the updated one or more second structured datasets.

7. The method of claim 5, further comprising:
allowing the first user to send another electronic message to users associated with the one or more second structured datasets.

8. The method of claim 1, wherein the electronic message is a group message, and wherein the input of the first information causes a broadcast message to be created.

9. The method of claim 1, wherein the input of the first information by the first user causes a change to the group, the method further comprising:
automatically updating the group to reflect the change to the group.

10. The method of claim 9, further comprising:
allowing one or more of the at least two users to input second information in the electronic message;
receiving the input second information; and
transmitting the input second information to the updated group.

11. The method of claim 10, wherein the input of the first information includes:
creating the interactive element embedded in the electronic message.

12. The method of claim 1, wherein the electronic message is related to an event.

13. The method of claim 1, wherein the input first information is received through the interactive element, and
wherein the allowance of the group access to the one or more structured datasets at the first time includes:
automatically updating graphical user interfaces of the electronic message to the group at the first time.

14. The method of claim 1, wherein the at least two users includes one or more of a: host, co-host, guest, and company.

15. The method of claim 1, wherein the allowance of the first user to input the first information in the electronic message using the first graphical user interface includes: allowing the first user to enter text on the first graphical user interface.

16. An electronic application comprising:
a transmitter that transmits one or more views of one or more interfaces of a display of a portable electronic device, the one or more views including information analyzed by and received from a server computer,
wherein a first interface of the one or more interfaces includes a first interactive element embedded in an electronic message; and
a receiver that receives input information from a touch screen of the portable electronic device and transmits the received input information to the server computer,
the input information associated with the first interactive element, and when received, causing the sever computer to automatically create or update one or more first structured datasets,
wherein the transmitter transmits a second interface of the one or more interfaces in response to updates to the one or more first structured datasets.

17. The electronic application of claim 16, wherein the second interface of the one or more interfaces includes the first interactive element and a second interactive element embedded in the electronic message.

18. The electronic application of claim 16, wherein the first interactive element includes at least one button, and the second interface is a view of a webpage associated with the at least one button of the first interactive element.

19. The electronic application of claim 16, wherein the first interface allows a user to input text into a field input, and the second interface displays the input text.

20. The electronic application of claim 16, wherein the electronic message is one of: a private message, a group message, and a broadcast message, and wherein the input information is related to an event.
